(19) United States
(12) Patent Application Publication
(10) Pub. No.: US 2020/0132283 A1
(43) Pub. Date: Apr. 30, 2020

(54) STAGE REPRESENTATION SYSTEM

(71) Applicant: ISA CO., LTD., Yokohama-shi, Kanagawa (JP)

(72) Inventor: Kiyoshi ISAYAMA, Tokyo (JP)

(73) Assignee: ISA CO., LTD., Yokohama-shi, Kanagawa (JP)

(21) Appl. No.: 16/605,721

(22) PCT Filed: Dec. 20, 2018
(86) PCT No.: PCT/JP2018/047015

§ 371 Date: Oct. 16, 2019

(30) Foreign Application Priority Data
Dec. 20, 2017 (JP) 2017-244404

(51) Int. Cl. F21V 21/16; F21S 8/06; F21V 21/38; F21V 27/00

(52) U.S. Cl. CPC F21V 21/16; F21S 8/061; F21W 2131/406; F21V 27/00; F21V 21/38

(57) ABSTRACT

A three-dimensional stage representation uses light including a plurality of lighting elements for example are independently elevated to thereby emit light from a lighting element. A three-dimensional stage representation system includes: an elevation device for elevating a to-be-lifted object; a to-be-lifted object connected to the elevation device via a reel wire; a suspension baton from which the elevation device is suspended; and a controller that is connected to the elevation device and the to-be-lifted object in a communicative manner and that can provide an independent control thereto.

### TECHNICAL FIELD

The present invention relates to a three-dimensional stage representation method and a three-dimensional stage representation system according to which a plurality of lighting elements for example are independently elevated in a theater, a concert hall, or a television studio for example to thereby provide a three-dimensional stage representation based on illumination. The invention also relates to an elevation device to elevate a lighting element for example in a three-dimensional stage representation system.

### BACKGROUND ART

Conventionally, in a theater, a concert hall, or a television studio for example, a stage representation has been provided to support performers providing a singing, theatrical, or dance performance for example. Such stage representations include the use of illumination devices such as an illumination device to emit light from the upper side of the stage, an illumination device to emit light from a floor face of the stage, an illumination device to uniformly illuminate the entire stage, and an illumination device to emit light to a specific performer for example. For example, the illumination device to emit light from the upper side of the stage (hereinafter referred to as a “upper stage illumination device”) is suspended from a suspension baton attached to a ceiling part and is connected to a controller that controls a plurality of illumination devices in an integrated manner. The suspension baton has a receptacle box including a tool connection power receptacle so that a power supply can be provided to the illumination device.

A stage representation system has been known in which a plurality of illumination devices are suspended from an elevation baton obtained by providing the suspension baton suspended from a cable so as to provide the elevating operation of the plurality of illumination devices (see Patent Literature 1 for example). Furthermore, an illumination posture control system has been known according to which a plurality of illumination devices suspended from the suspension baton are individually elevated to provide a control by which illumination depending on an illumination illuminance design is provided at a predetermined position on the stage (see Patent Literature 2 for example).

### CITATION LIST

### Patent Literature

[Patent Literature 1] Japanese Patent Laid-Open No. H8-148005
[Patent Literature 2] Japanese Patent Laid-Open No. H11-135270

### SUMMARY

The above-described conventional illumination device has an objective of illuminating a predetermined position on the stage or a performer on the stage, i.e., emitting light having predetermined color and illuminance within a predetermined range. Specifically, the conventional illumination device uses light emitted from the illumination device only in a complementary manner so that a specific location on the stage, a stage set, stage properties, or a performer is highlighted by light. On the other hand, some theatrical performances for example directly use an illumination device as stage properties (e.g., a red paper restaurant lantern, an illumination sign board) as a representation device.

However, in the case of the conventional illumination device, the light emitted from the illumination device is not directly used as one of stage properties or as a part of the representation.

One embodiment of the present invention provides a three-dimensional stage representation method and a three-dimensional stage representation system by which a plurality of lighting elements for example are elevated independently to thereby provide a three-dimensional stage representation using light emitted from the lighting elements. An elevation device according to one embodiment of the present invention elevates the lighting elements for example in the three-dimensional stage representation system.

The three-dimensional stage representation system according to one embodiment of the present invention include: an elevation device for elevating a to-be-lifted object; a to-be-lifted object connected to the elevation device via a reel wire; a suspension baton from which the elevation device is suspended; and a controller that is connected to the elevation device and the to-be-lifted object in a communicative manner and that can provide an independent control thereto.

According to this configuration, the controller can control the plurality of elevation devices to independently elevate a plurality of to-be-lifted objects to thereby provide a three-dimensional stage representation. Lighting elements as a to-be-lifted object can be controlled in a coordinated manner to thereby provide a three-dimensional stage representation using light emitted from the lighting elements.

### BRIEF DESCRIPTION OF DRAWINGS

FIG. 1 illustrates the entire configuration of a three-dimensional stage representation system according to one embodiment of the present invention.

FIG. 2 is a block diagram illustrating the three-dimensional stage representation system according to one embodiment of the present invention.

FIG. 3 illustrates an embodiment of the three-dimensional stage representation system according to one embodiment of the present invention.

FIG. 4 illustrates the entire configuration of the three-dimensional stage representation system according to another embodiment.

FIG. 5 is a block diagram illustrating the three-dimensional stage representation system according to another embodiment.

FIG. 6 illustrates the entire configuration of an elevation device according to the first embodiment of the present invention.

FIG. 7 illustrates the configuration of a guide ring of the elevation device of the first embodiment.

FIG. 8 illustrates the entire configuration of the elevation device according to the second embodiment of the present invention.

FIG. 9 illustrates the configuration of the guide ring of the elevation device of the second embodiment.

FIG. 10 illustrates the entire configuration of the elevation device according to the third embodiment of the present invention.

FIG. 11 illustrates the internal structure of a reel of the third embodiment.

FIG. 12 is a schematic view illustrating the connection in the reel of the third embodiment.

FIG. 13 illustrates an LED ball of a lighting element as a to-be-lifted object.

FIG. 14 illustrates a mirror as a to-be-lifted object.

FIG. 15 illustrates an LED-mounted mirror of a lighting element as a to-be-lifted object.

FIG. 16 illustrates the relation between a mirror and the LED-mounted mirror and the elevation device.

FIG. 17 illustrates an LED bar of a lighting element as a to-be-lifted object.

FIG. 18 illustrates the relation between the LED bar and the elevation device.

FIG. 19 illustrates a display panel of the lighting element as a to-be-lifted object.

FIG. 20 illustrates LED crystal of a lighting element as a to-be-lifted object.

FIG. 21 illustrates the LED earth of a lighting element as a to-be-lifted object.

FIG. 22 illustrates the LED earth according to another embodiment.

FIG. 23 illustrates an LED balloon of a lighting element as a to-be-lifted object.

FIG. 24 illustrates an LED triangle of a lighting element as a to-be-lifted object.

FIG. 25 is a flow diagram illustrating the basic control of the elevation device and the to-be-lifted object.

FIG. 26 illustrates a three-dimensional stage representation method using the LED ball according to one embodiment of the present invention.

FIG. 27 illustrates representation data stored in a device control unit of the c.

FIG. 28 illustrates a three-dimensional stage representation method using the LED ball according to one embodiment of the present invention.

FIG. 29 illustrates Illustrative Embodiment 1 of the three-dimensional stage representation method using the mirror according to one embodiment of the present invention.

FIG. 30 illustrates Illustrative Embodiment 2 of the three-dimensional stage representation method using the mirror.

FIG. 31 illustrates Illustrative Embodiment 3 of the three-dimensional stage representation method using the mirror.

FIG. 32 illustrates Illustrative Embodiment 4 of the three-dimensional stage representation method using the mirror.

FIG. 33 illustrates Illustrative Embodiment 5 of the three-dimensional stage representation method using the mirror.

FIG. 34 illustrates Illustrative Embodiment 1 of the three-dimensional stage representation method using a bar according to one embodiment of the present invention.

FIG. 35 illustrates Illustrative Embodiment 2 of the three-dimensional stage representation method using the bar.

FIG. 36 illustrates Illustrative Embodiment 3 of the three-dimensional stage representation method using the bar.

FIG. 37 illustrates Illustrative Embodiment 1 of three-dimensional stage representation method using the display panel according to one embodiment of the present invention.

FIG. 38 illustrates Illustrative Embodiment 2 of the three-dimensional stage representation method using the display panel.

FIG. 39 illustrates the three-dimensional stage representation method using the LED triangle according to one embodiment of the present invention.

### DESCRIPTION OF EMBODIMENTS

The following section will describe an embodiment of the present invention with reference to the drawings.

[1. Three-Dimensional Stage Representation System]

(Wired Control Method)

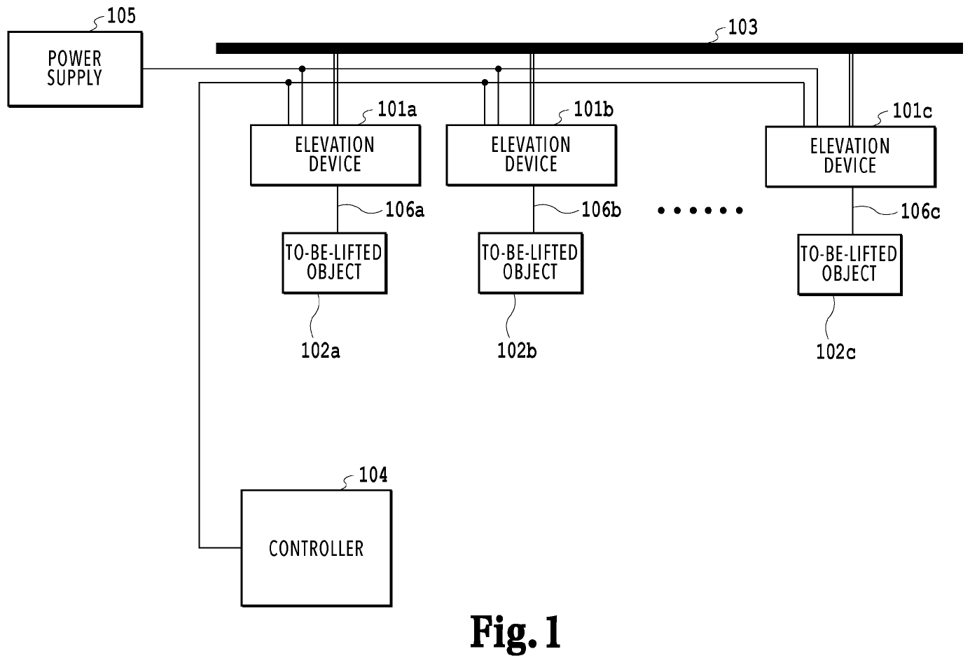

FIG. 1 illustrates the entire configuration of a three-dimensional stage representation system according to one embodiment of the present invention. The three-dimensional stage representation system includes: elevation devices 101a-101c to elevate to-be-lifted objects; to-be-lifted objects 102a-102c connected to the respective elevation devices 101a-101c via reel wires 106a-106c; a suspension baton 103 from which the elevation devices 101a-101c are suspended; and a controller 104 that is communicatively connected to the elevation devices 101a-101c and the to-be-lifted objects 102a-102c to provide an independent control thereto. The suspension baton 103 includes a tool connection power receptacle. A power supply 105 supplies power to the elevation devices 101a-101c and the to-be-lifted objects 102a-102c.

The elevation devices 101a-101c may be directly attached to a ceiling above the stage without bypassing the suspension baton 103 or may be attached to another structure on the stage. The to-be-lifted object 102 mainly includes various lighting elements but also includes, as described later, an object not including a lighting element such as a mirror or a cut glass ornament.

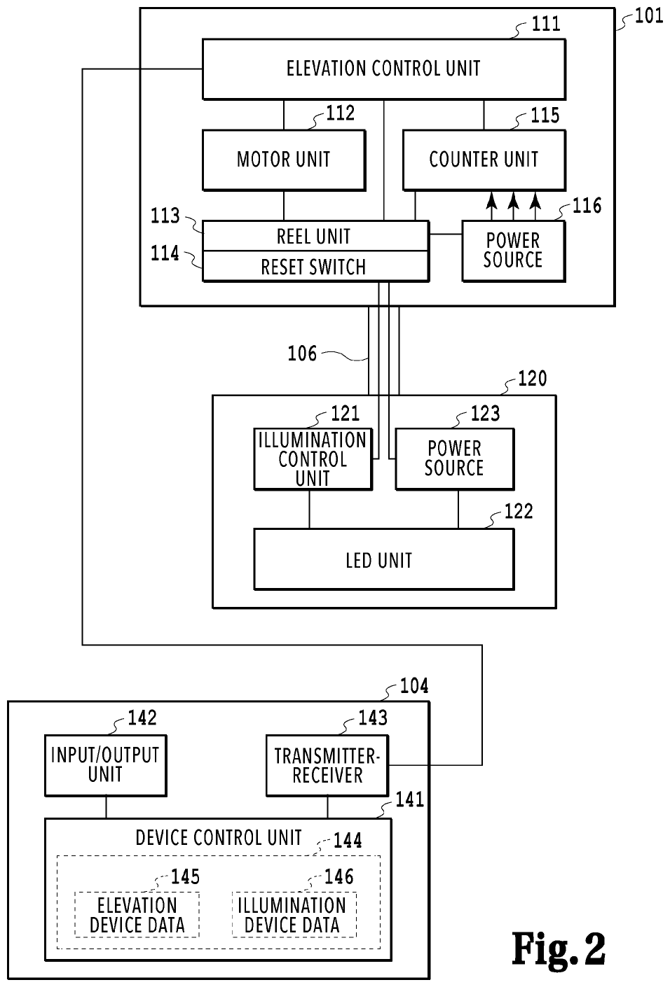

FIG. 2 is a block diagram illustrating the three-dimensional stage representation system according to one embodiment of the present invention. The elevation device 101 includes: an elevation control unit 111 for controlling the respective components; a motor unit 112 that is connected to the input and output of the elevation control unit 111 and that supplies power; a reel unit 113 that is connected to the motor unit 112 and that winds or unwinds a reel wire 106; a reset switch 114 that is connected to the reel unit 113 and that sets a reference value to calculate the length of the reel wire 106 wound or unwound around the reel unit; a counter unit 115 that is connected to an output of the reel unit 113 and that monitors the length of the reel wire; and a power source 116 that allocates the electric power from the power supply 105 to the interior of the elevation device 101 and the to-be-lifted object 102.

The following section will exemplarily describe a lighting element 120 as the to-be-lifted object 102. The lighting element 120 includes: an illumination control unit 121 for controlling the respective components; an LED unit 122 that is connected to the input/output of the illumination control unit 121 and that includes one or more LED chip(s); and a power source 123 that supplies electric power to the illumination control unit 121 and the LED unit 122.

The reel wire 106 includes a control line that connects the elevation control unit 111 and the illumination control unit 121; and a power line that connects the power source 116 of the elevation device 101 and the power source 123 of the lighting element 120.

The controller 104 includes: a device control unit 141 that controls the elevation device 101 and the lighting element 120, respectively; an input/output unit 142 that is connected to the input/output of the device control unit 141 to provide a user interface; and a transmitter-receiver 143 that can communicate with the elevation device 101 and the lighting element 120, respectively. The device control unit 141 has a memory 144 to store data. The memory 144 stores therein elevation device data 145 including data for the respective elevation devices; and illumination device data 146 including data for the respective lighting elements as data for the respective to-be-lifted objects.

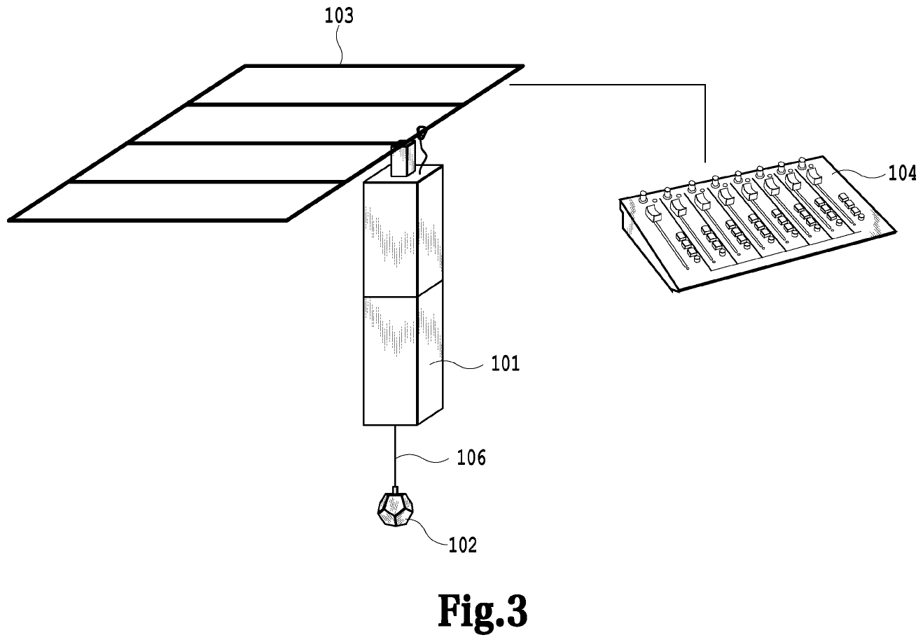

FIG. 3 illustrates an embodiment of the three-dimensional stage representation system according to one embodiment of the present invention. The suspension baton 103 is attached to the ceiling of a theater, a concert hall, or a television studio for example. The suspension baton 103 is a steel-made machinery that has a bar-like shape shown in FIG. 1 or a well curb-like shape shown in FIG. 3 for example. A plurality of elevation devices and a plurality of lighting element are attached to the suspension baton 103. The elevation device 101 has an elongate rectangular parallelepiped-like shape extending in a vertical direction. By reducing the area on the horizontal plane, more elevation devices 101 can be suspended from the suspension baton 103. The to-be-lifted object 102 is illustrated as an LED ball as a lighting element.

The device control unit 141 of the controller 104 has a device control unit including a CPU (Central Processing Unit) or an FPGA (Field Programmable Gate Array) for example and executes a stage representation based on a control program and representation data stored in the memory 144. The controller 104 is provided in a control room or an audience seating of a theater for example and is operated by an interpreter responsible for illumination. The configuration as described above provides a three-dimensional stage representation system for providing a three-dimensional stage representation by independently elevating a plurality of lighting elements (to-be-lifted objects).

(Wireless Control Method)

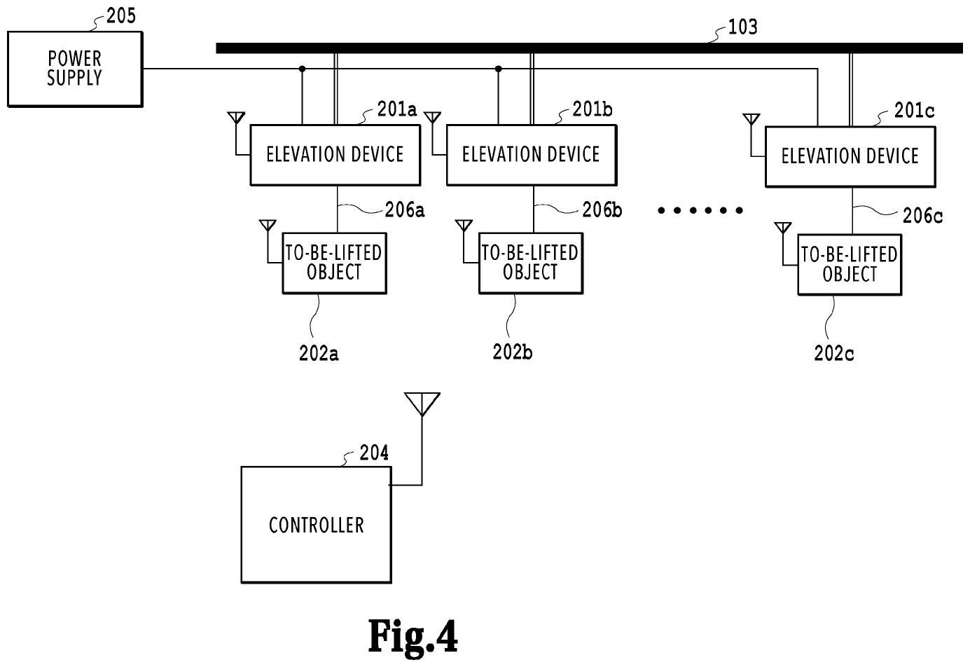

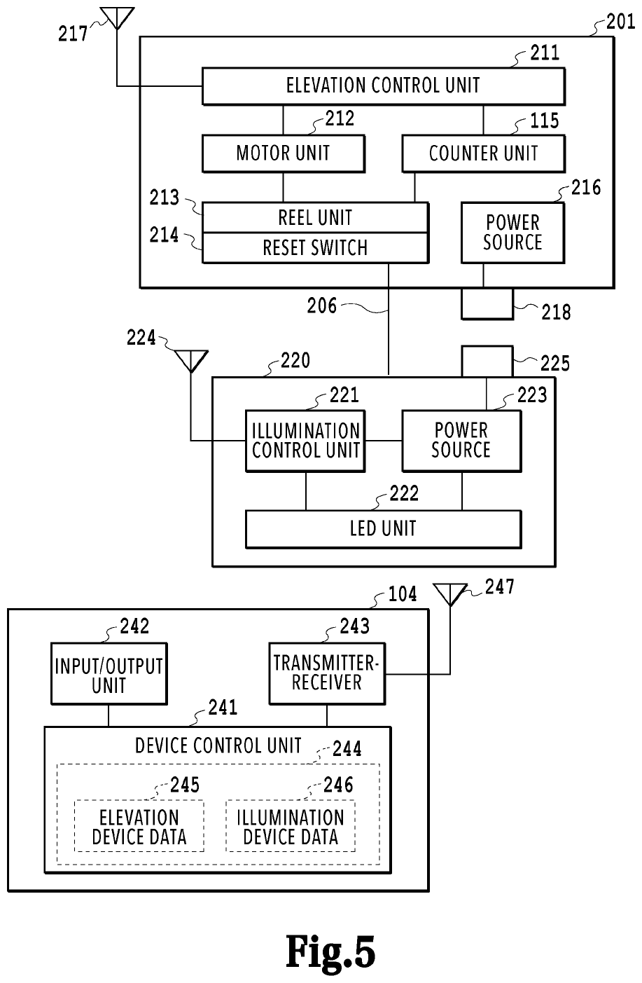

Another embodiment of the three-dimensional stage representation system is shown in FIG. 4 and FIG. 5 in which the controller provides a control via wireless connection. The three-dimensional stage representation system includes: elevation devices 201a-201c for elevating a to-be-lifted object; to-be-lifted objects 202a-202c connected to the respective elevation devices 201a-201c via the reel wires 206a-206c; the suspension baton 103 from which the elevation devices 201a-201c are suspended; and a controller 204 that is wirelessly connected to the elevation devices 201a-201c and the to-be-lifted objects 202a-202c, respectively, and that can provide an independent control thereto. The suspension baton 103 includes a tool connection power receptacle. The power supply 105 provides a power source to the elevation devices 201a-201c.

The elevation device 201 includes: an elevation control unit 211 for controlling the respective components; a motor unit 212 that is connected to the input/output of the elevation control unit 211 to supply power; a reel unit 213 that is connected to the motor unit 212 and that winds or unwinds a reel wire 206; a reset switch 214 that is connected to the reel unit 213 and that sets a reference value used to calculate the length of the reel wire 206 wound or unwound around the reel unit; a counter unit 215 that is connected to an output of the reel unit 213 and that monitors the length of the reel wire; an antenna unit 217 that is connected to the input/output of the elevation control unit 211 to communicate with the controller; a charge unit 216 for charging the to-be-lifted object; and a connector unit 218 that is connected to the charge unit 216 and that is detachably attached to the opposed connector unit of the to-be-lifted object.

The following section will describe a lighting element 220 as a to-be-lifted object 202. The lighting element 220 includes: an illumination control unit 221 for controlling the respective components; an antenna unit 224 that is connected to the input/output of the illumination control unit 221 to communicate with the controller; an LED unit 222 including one or more LED chip(s); a power source 223 that includes a battery capable of charging and discharging electricity and that supplies electric power to the illumination control unit 221 and the LED unit 222; and a connector unit 225 that is connected to the power source 223 and that is detachably attached to the opposed connector unit 218 of the elevation device.

The reel wire 206 is a wire rod such as a nylon gut from which the to-be-lifted object 202 can be suspended. When compared with the wired control method, the lighting element 220 including a battery has a proportionally-increased weight. However, since the reel wire 206 does not have to include a power line or a control line, a reel (which will be described later) to wind the reel wire can have a smaller size, thus allowing the elevation device to have a smaller size.

The controller 204 includes: a device control unit 241 for controlling the elevation device 201 and the lighting element 220, respectively; an input/output unit 242 connected to the input/output of the device control unit 241 to provide a user interface; a transmitter-receiver 243 that can communicate with the elevation device 201 and the lighting element 220, respectively; and an antenna unit 247 connected to the input/output of the transmitter-receiver 243 to communicate with the elevation device 201 and the lighting element 220, respectively. The device control unit 241 has a memory 244 for storing data. The memory 244 stores therein an elevation device data 245 including data for the respective elevation devices; and a illumination device data 246 including data for the respective lighting elements.

The elevation device 201, the lighting element 220, and the controller 204 can provide an independent one-to-one wireless connection, via the respective antennas, between the controller 204 and the elevation device 201 and the lighting element 220. For example, the controller 204 can be operated to individually send, to the elevation device 201, an instruction signal to lower the lighting element 220. The controller 204 can be operated to individually send, to the lighting element 220 without bypassing the elevation device 201, an instruction signal to turn ON or OFF LED light.

[2. Elevation Device]

### First Embodiment

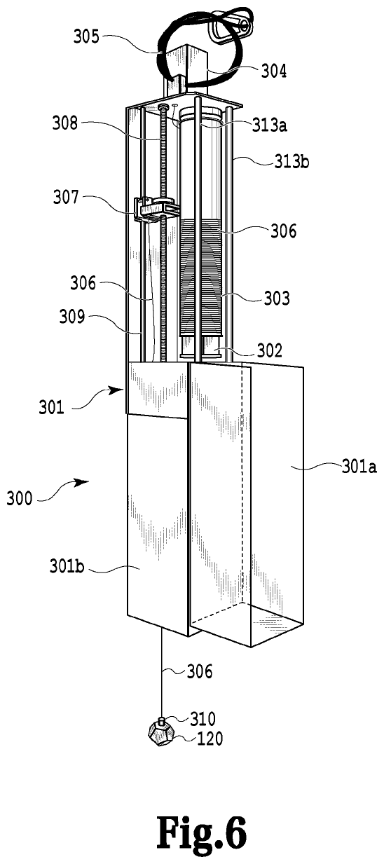

FIG. 6 illustrates the entire configuration of the elevation device according to the first embodiment of the present invention. An elevation device 300 includes a housing 301 and a reel 303 connected to an electric motor 302 and is covered with an upper housing cover 301a. The housing 301 has a rectangular parallelepiped extending in the vertical direction and has a lower housing 301b including therein an elevation control unit, a reset switch, a counter unit, and a power source. The housing 301 has an upper face that has an attaching part 304 used to attach the suspension baton and an attaching hook 305 used for fall prevention. A reel wire 306, which is connected to the lighting element 120 as a to-be-lifted object, extends through the opening of the lower face of the lower housing 301b to pass through a reset switch (not shown) and the interior of the lower housing 301b and is wound around a surface of the reel 303 (winding face) via a guide ring 307.

The reel 303 has a cylindrical shape and is provided so as to have the longitudinal direction thereof parallel to the longitudinal direction (vertical direction) of the housing 301. The reel 303 is connected to the electric motor 302. The reel 303 is caused to rotate around a cylindrical central axis by the rotation of the electric motor 302. A guide screw 308 and a guide rod 309 are provided so that the longitudinal direction thereof is parallel to the longitudinal direction of the reel 303. The guide screw 308 is caused to rotate by the rotation of the reel 303.

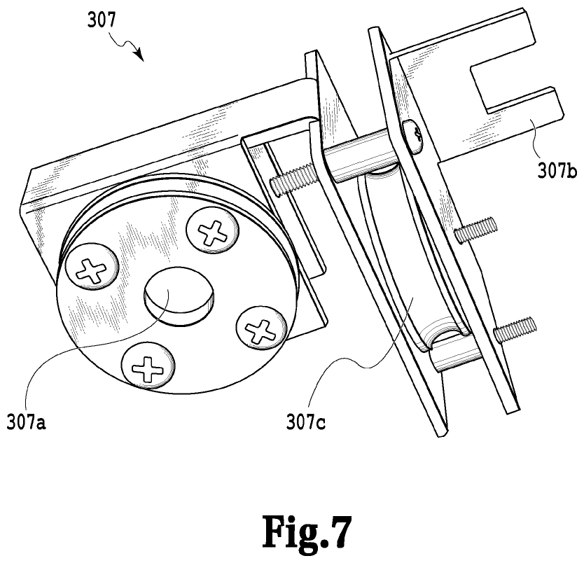

FIG. 7 illustrates the configuration of a guide ring of the elevation device of the first embodiment. The guide ring 307 has an axis hole 307a to which the guide screw 308 is inserted. The guide rod 309 is inserted to a U-shaped member 307b so as to prevent the guide ring 307 from being caused to rotate by the rotation of the guide screw 308. This consequently allows the guide ring 307 to move in the up-and-down direction in the vertical direction by the rotation of the guide screw 308. A pulley 307c having a rotation axis in the horizontal direction is inserted to the guide ring 307. The reel wire 306 extending through the lower housing 301b in the vertical direction is re-orientated by the pulley 307c in the horizontal direction and is wound around the winding face of the reel 303.

The guide screw 308 is threaded so that the guide ring 307 is moved by a distance corresponding to the diameter of the reel wire 306 whenever the reel 303 has one rotation. In this manner, the reel wire 306 is wound from the lower side to the upper side of the reel 303. Whenever the reel 303 has one rotation, the reel wire 306 is wound around the winding face of the reel 303 to provide a single winding. Alternatively, the reel wire 306 is sequentially unwound from the upper side to the lower side.

The reel wire 306 has a connector 310 at a tip end and is attached with the lighting element 120 via the connector 310. The lighting element 120 attached to the tip end of the reel wire 306 is suspended downwardly from the elevation device 300 and is elevated by allowing the reel wire 306 to be wound and unwound around the reel 303. The reel wire 306 is a cable inserted with a control line to connect the elevation control unit to the illumination control unit of the lighting element 120 and a power line to connect the power source of the elevation device 300 to the power source of the lighting element 120.

In this embodiment, a cable is used that includes three strand wires and a shielding wire among which a pair of two wires is used as a control line and the remaining one wire and the shielding wire are used as a power line. Alternatively, a three-wire control method can be used by which three wires are allocated to RGB and the shielding wire functions as a common return line providing both of a power supply and a control. When a plurality of reel wires are used to elevate one to-be-lifted object, then one reel wire is used as a control line and a power line and other reel wires are used as two pairs of power lines, thereby increasing the power supply to the to-be-lifted object.

Alternatively, a three-wire cable includes a control line and a return line functioning as a power line or a four-wire cable including two pairs of twisted pair wires also may be used. Thus, the wiring configuration of the reel wire 306 is not limited.

Columns 313a and 313b and a reeling guide (not shown) provided from the guide screw 308 at an opposite side to sandwich the reel 303 are provided so that the longitudinal direction thereof is parallel to the longitudinal direction of the reel 303. The following section will describe the structure and function of the reeling guide in the following second embodiment.

The elevation device 300 has an elevation control unit that has a CPU (Central Processing Unit), a FPGA (Field Programmable Gate Array), and a memory for example. The elevation control unit controls the interior of the elevation device 300 based on an instruction signal from the controller 104 to send state data to the controller 104. An instruction signal to a lighting element (to-be-lifted object) is transferred to the illumination control unit of the lighting element via a control line. The instruction signal also may be converted to an instruction signal suitable for the above-described wiring configuration or may be signal-converted depending on the configuration of the to-be-lifted object.

### Second Embodiment

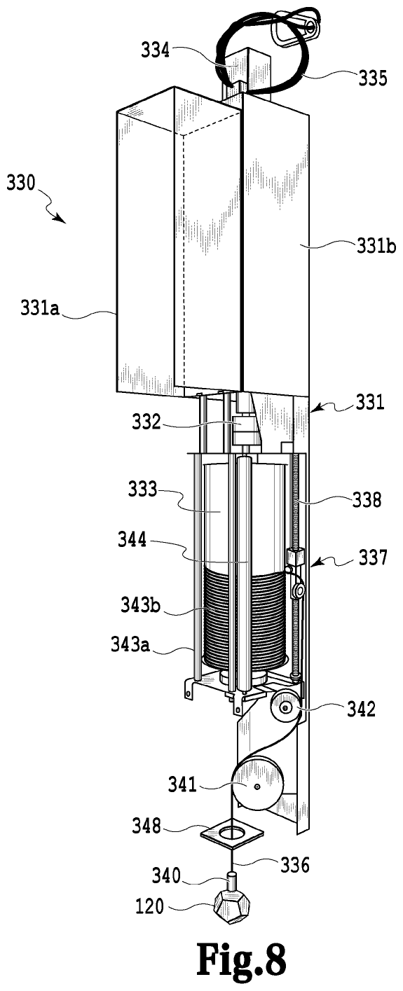

FIG. 8 illustrates the entire configuration of the elevation device according to the second embodiment of the present invention. An elevation device 330 has a housing 331 that has a reel 333 connected to an electric motor 332 and that is covered by a lower housing cover 331a. The housing 331 has a rectangular parallelepiped extending in the vertical direction. An upper housing 331b includes therein an elevation control unit, a counter unit, and a power source. The upper face of the housing 331 has an attaching part 334 used to attach the suspension baton and an attaching hook 335 for fall prevention. A reel wire 336, which is connected as a to-be-lifted object to the lighting element 120, extends from the opening of the lower face of the lower housing to pass through a reset switch 348 and is wound around the reel 333 via pulleys 341 and 342 and a guide ring 337.

The reel 333 has a cylindrical shape and is provided so that the longitudinal direction thereof is parallel to the longitudinal direction of the housing 331 (vertical direction). The reel 333 is connected to the electric motor 332 and is rotated around the cylindrical central axis by the rotation of the electric motor 332. A guide screw 338 is provided so that the longitudinal direction thereof is parallel to the longitudinal direction of the reel 333. The guide screw 338 is rotated by the rotation of the reel 333.

Columns 343a and 343b and a reeling guide 344 are provided so that the longitudinal direction thereof is parallel to the longitudinal direction of the reel 333. The reeling guide 344 is a cylindrical rotation body and is freely rotated around a cylindrical central axis. The reeling guide 344 has a circumferential surface made of elastic material such as sponge, resin, or rubber and has a contact with the reel wire 336 wound around the reel 333. The rotation of the reel 333 allows the reeling guide 344 to have a contact with the reel wire 336 wound around the reel 333 and the reeling guide 344 is rotated in a reverse direction while depressing the reel wire 336 to the winding face of the reel 333.

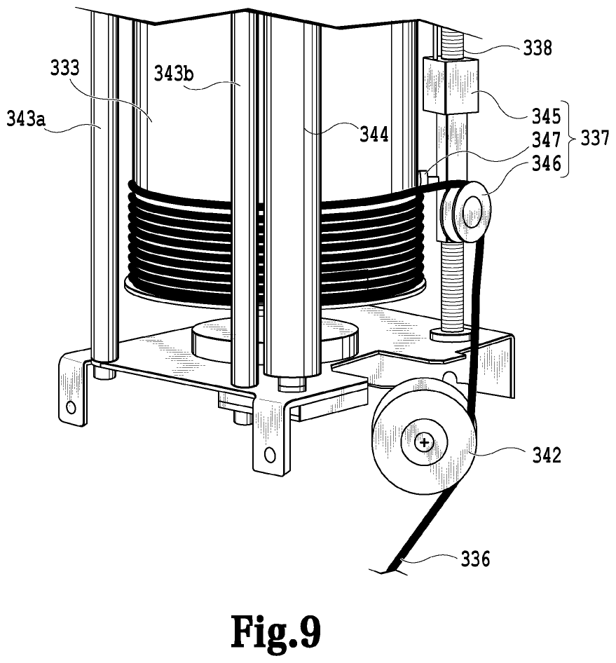

FIG. 9 illustrates the configuration of a guide ring of the elevation device of the second embodiment. The guide ring 337 has an axis hole of a guide block 345 to which the guide screw 338 is inserted. The guide block 345 has a side face slid over the inner face of the housing 331 so that the guide ring 337 is not caused to rotate by the rotation of the guide screw 338. This allows the guide ring 337 to move in the up-and-down direction in the vertical direction by the rotation of the guide screw 338. The guide ring 337 is attached with a pulley 346 having a rotation axis in the horizontal direction. The reel wire 336 extending through a pulley 342 in the vertical direction is re-oriented by the pulley 346 in the horizontal direction and is wound around the winding face of the reel 333.

The guide screw 338 is threaded so that the guide ring 337 is moved by a distance corresponding to the diameter of the reel wire 336 whenever the reel 333 has one rotation. In this manner, the reel wire 336 is wound from the lower side to the upper side of the reel 333. Whenever the reel 303 has one rotation, the reel wire 336 is wound to provide a single winding or the reel wire 336 is sequentially unwound from the upper side to the lower side. The guide ring 337 has a reel wire fixing part 347 and has a function to depress the reel wire 336 in the vertical direction lower (in the lower direction in FIG. 9) so that the reel wire 336 wound around the reel 333 is aligned.

According to the elevation device of the second embodiment, when the reel wire 336 is wound around the reel 333 to provide a single winding, the reeling guide 344 and the reel wire fixing part 347 can provide a winding operation in a minute and more accurate manner. The guide ring having a smaller size can provide, when compared with the first embodiment, the housing 331 having a horizontal plane having a smaller area. This can consequently allow elevation devices to be suspended from the suspension baton with a narrower interval, thus providing a more colorful representation.

The reel wire 336 has a connector 340 at a tip end. The reel wire 336 is attached to the lighting element 120 via the connector 340. The lighting element 120, which is attached to the tip end of the reel wire 336, is suspended downwardly from the elevation device 330. The lighting element 120 is lifted and lowered by winding and unwinding the reel wire 336 around the reel 333. As in the first embodiment, the reel wire 336 is a cable of two pairs of four wires to which the control line and the power line are inserted.

### Third Embodiment

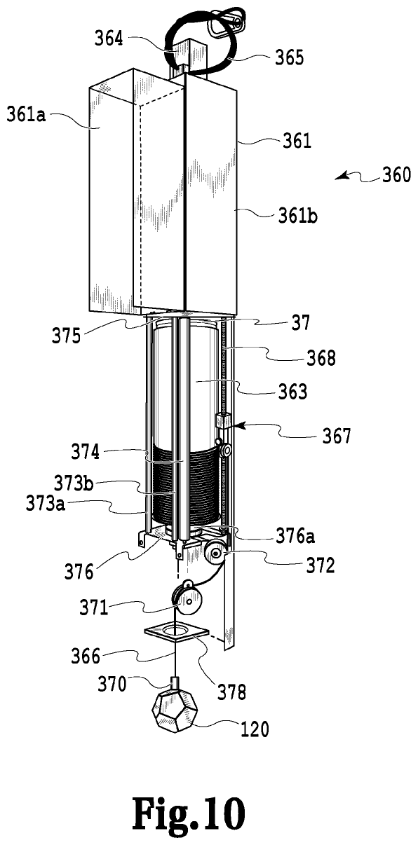

FIG. 10 illustrates the entire configuration of the elevation device according to the third embodiment of the present invention. An elevation device 360 is configured so that a housing 361 includes a reel 363 including therein an electric motor and a counter unit and being covered by the lower housing cover 361a. The housing 361 has a rectangular parallelepiped extending in the vertical direction. An upper housing 361b includes therein an elevation control unit and a power source. The upper face of the housing 361 has an attaching part 364 used for the attachment of the suspension baton and an attaching hook 365 for fall prevention. A reel wire 366, which is connected as a to-be-lifted object to the lighting element 120, extends through the opening of the lower face of the lower housing to pass a reset switch 378 and is wound around the winding face of the reel 363 via pulleys 371 and 372 and a guide ring 367.

The reel 363 has a cylindrical shape and is provided so that the longitudinal direction is parallel to the longitudinal direction of the housing 361 (vertical direction). The reel 363 is rotated around the cylindrical central axis by the rotation of the built-in electric motor. A guide screw 368 is provided so that the longitudinal direction thereof is parallel to the longitudinal direction of the reel 363. The guide screw 368 is rotated by the rotation of the reel 363.

Columns 373a and 373b and a reeling guide 374 are provided so that the longitudinal direction thereof is parallel to the longitudinal direction of the reel 363. The reeling guide 374 has the same structure and function as those of the second embodiment. The guide ring 367 is the same as the guide ring of the second embodiment shown in FIG. 9.

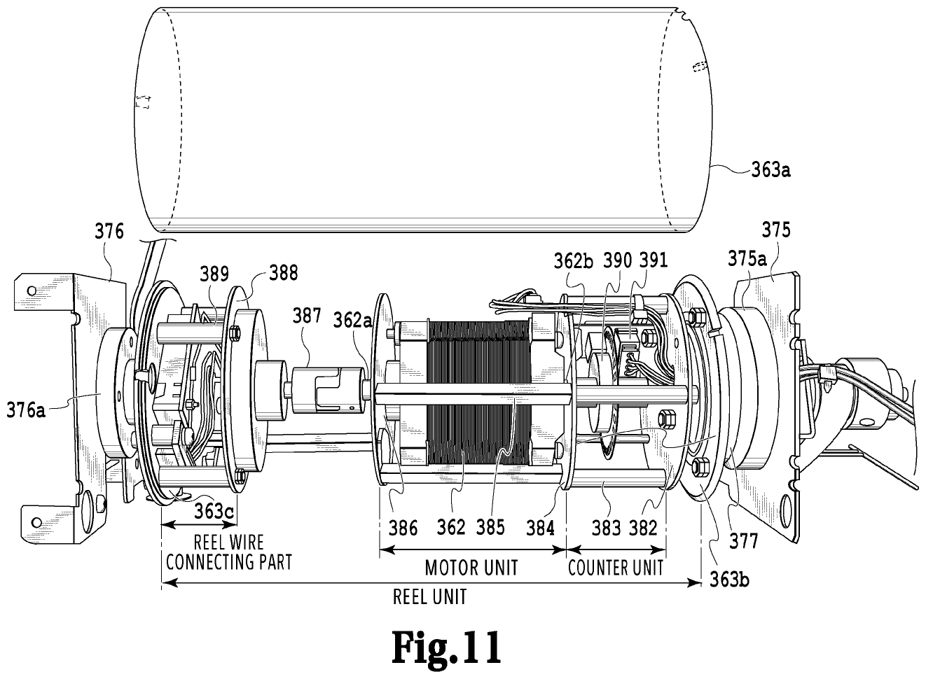

FIG. 11 shows the internal structure of the reel of the third embodiment. The reel 363 is provided between an upper support plate 375 and a lower support plate 376 provided in the housing 361 and is configured by a reel wire winding face 363a, an upper fitting plate 363b, and a lower fitting plate 363c. The reel 363 includes therein a counter unit, a motor unit, and a reel wire connecting part mounted from the upper side in the vertical direction.

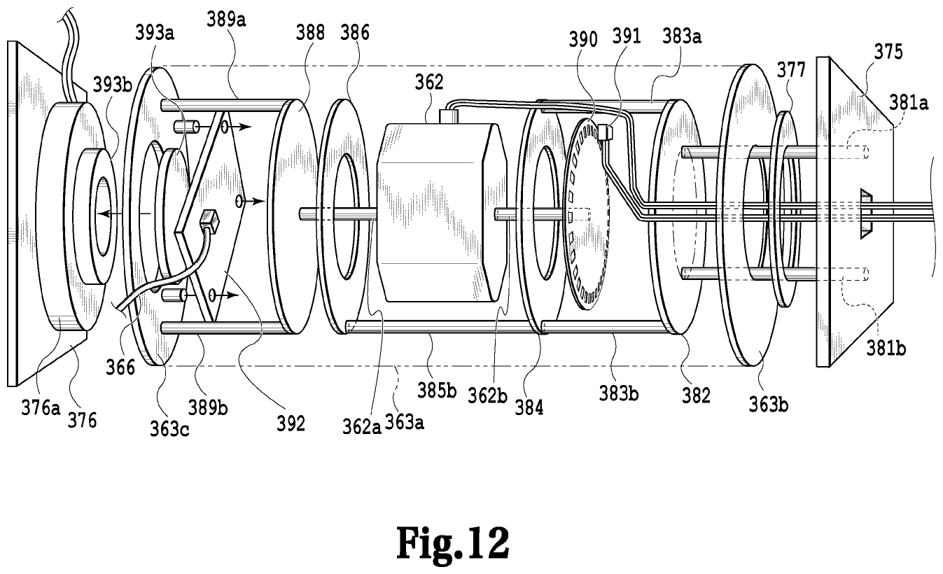

With reference to FIG. 12, the following section will describe the internal connection of the reel of the third embodiment. FIG. 12 illustrates a simplified connection relation by omitting a part of the components or by using simplified expression. The upper support plate 375 and the upper fitting plate 363b of the reel 363 have therebetween a bearing 377 fixed to a support base 375a. The upper fitting plate 363b and the bearing 377 have an opening provided around the central axis of the reel 363. Through this opening, columns 381a and 381b are used to fix a counter support plate 382 to the upper support plate 375. Furthermore, the columns 383a and 383b are used to fix an upper motor support plate 384 to the counter support plate 382. A column 385a (not shown) and a column 385b are used to fix a lower motor support plate 386 to the upper motor support plate 384.

An electric motor 362 is fixed between the upper motor support plate 384 and the lower motor support plate 386. One rotation axis 362a is connected to a reel wire connecting part via a coupling 387 and the other rotation axis 362b is connected to a cord wheel 390 of the counter unit. The coupling 387 is connected to the lower fitting plate 363c via a reel wire connector support plate 388 and columns 389a and 389b. This allows the electric motor 362 to be fixed to the housing 361 by the upper support plate 375 to rotate the reel 363 fixed to the lower fitting plate 363c.

The counter unit has a detection circuit 391 having a pair of a light emission element and a light reception element provided so as to sandwich the cord wheel 390. The detection circuit 391 is fixed to the counter support plate 382. The detection circuit 391 counts the rotation angle of the reel 363 by the rotation of the electric motor 362 and thus can calculate the length of the reel wire wound or unwound around the reel based on the reel rotation number and the rotation angle. The power line and the control line to the electric motor 362 as well as the signal line from the detection circuit 391 extend through the above-described upper fitting plate 363b and the opening of the bearing 377 and pass through the upper support plate 375 to be connected to the elevation control unit of the upper housing 361a and the power source.

The reel wire connecting part has an end of the reel wire 366 wound around the reel wire winding face 363a of the reel 363 that is connected via a connector to a connection board 392 and that is connected to a slide electrode inserted to a bearing 393a. The bearing 393a is opposed to a bearing 393b fixed to a support base 376a and slide electrodes are inserted to those bearings, respectively. By the configuration as described above, a power line inserted to the reel wire 366 to provide a power source to the lighting element 120 and a control line for controlling the lighting element 120 are connected to an elevation control unit in the upper housing 361b.

According to the elevation device according to the third embodiment, the electric motor and the counter unit provided in the reel 363 can reduce, when compared with the first and second embodiments, the length of the housing 361 in the vertical direction, thus providing the elevation device having a smaller size. The elevation device having a lighter weight allows more objects to be suspended from the suspension baton, thus providing more colorful representations.

(Reset Switch)

The following section will describe a reset switch commonly used in the elevation device of the first to third embodiments. The reset switch is attached to the neighborhood of the opening of the lower face of the lower housing of the elevation device. The reset switch has a penetration hole through which the reel wire and the connector can be inserted. When the reel wire is wound around the reel to lift the to-be-lifted object, the to-be-lifted object is abutted to the penetration hole of the reset switch and cannot be lifted any more. The reset switch detects a state in which the to-be-lifted object is abutted to the penetration hole.

In the representation by the three-dimensional stage representation system, a to-be-lifted object is firstly suspended from an elevation device. Then, the elevation device is controlled by the controller to raise the to-be-lifted object to a position at which the to-be-lifted object is detected by the reset switch. The controller assumes the position detected by the reset switch as a reference point (e.g., a position at which the reel wire has the length L=0 m) to use this position as a reference of the subsequent up-and-down move of the to-be-lifted object by the elevation device.

[3. To-be-Lifted Object]

### (Led Ball)

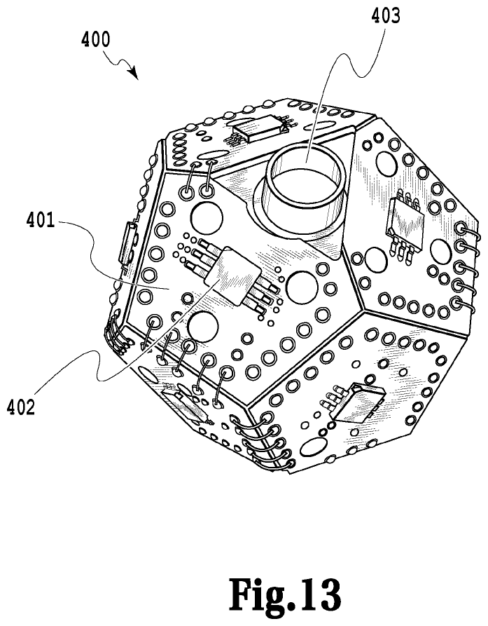

FIG. 13 illustrates the appearance of the LED ball as a lighting element as a to-be-lifted object. An LED ball 400 is configured so that pentagon hexagon-shaped mounting boards 401 are connected to form a spherical shape such as a soccer ball. Each board surface has thereon LED chips 402. The back face of the board and the back side of the LED chip 402 have IC chips functioning as an illumination control unit and a power source. A control line connected to the illumination control unit and a power source connected to a power line are connected to the reel wire via a connector 403.

In the three-dimensional stage representation system shown in FIG. 1, the controller 104 is communicatively connected to illumination control unit 121 (IC chip) of the lighting element 120 (LED ball) via the elevation control unit 111 of the elevation device 101, thus providing a control of the light emission, the light OFF, the illuminance, and the colors of the individual LED chips.

(Mirror)

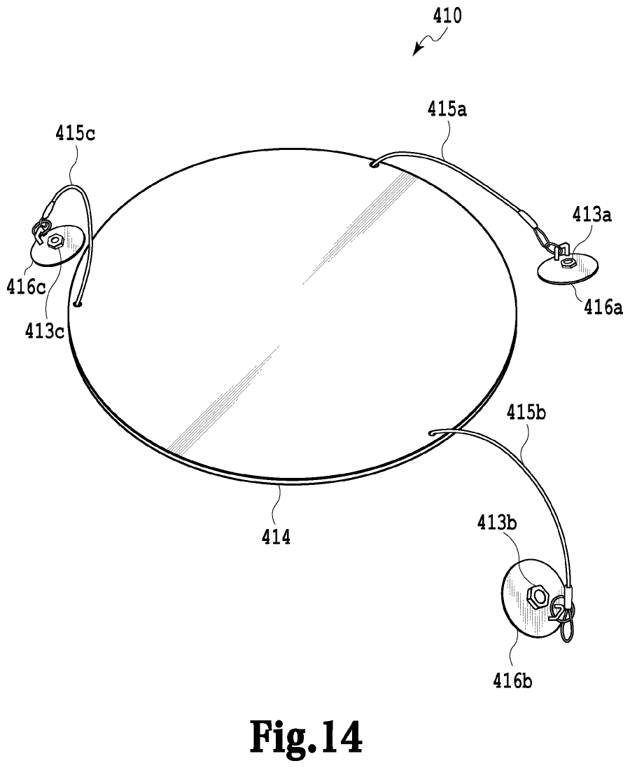

FIG. 14 illustrates a mirror as a to-be-lifted object. A mirror 410, which is a reflective member, is a double face mirror 414 having a circular shape and consisting of an acrylic flat plate. Three points at the outer circumference of the double face mirror 414 are attached with suspension lines 415a-415c connected to connectors 413a-413c. The mirror 410 does not include a lighting element. Thus, the reel wire connected to the connector 413 is used only as a suspension line to provide the up-and-down move of the mirror 410. A representation method using this mirror as a part of the illumination device will be described later.

The connector 413 of the suspension line 415 is attached with a reset plate 416. The reset plate 416 is an arbitrary-shaped plate that does not pass through the penetration hole of the above-described reset switch.

(LED-Mounted Mirror)

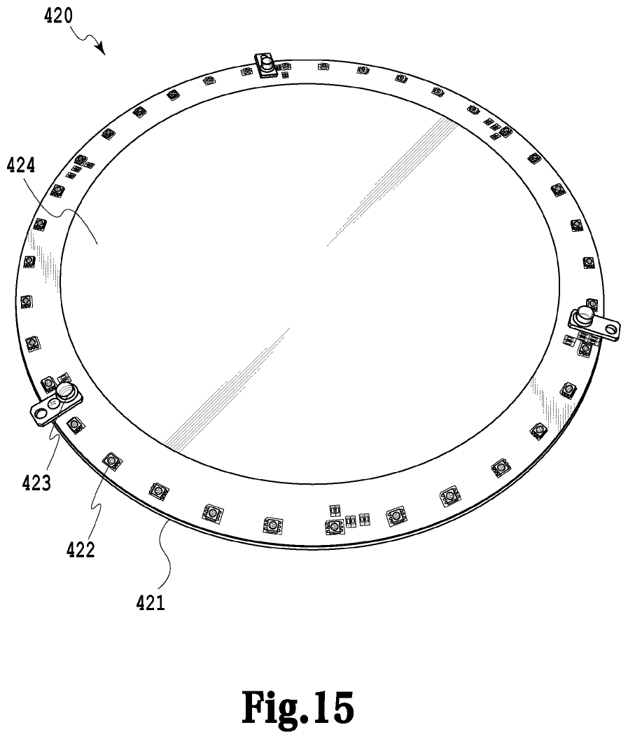

FIG. 15 illustrates an LED-mounted mirror of a lighting element as a to-be-lifted object. The LED-mounted mirror 420 includes: a circular double face mirror 424 consisting of a flat acrylic plate; and a doughnut-shaped mounting board 421 attached to the outer circumference thereof. The mounting board 421 has a surface including a plurality of LED chips 422. The back face of the board and the back side of the LED chip 422 have IC chips functioning as an illumination control unit and a power source. The back face of the mounting board 421 also can have thereon not only an IC chip but also an LED chip.

In the three-dimensional stage representation system shown in FIG. 1, the controller 104 is communicatively connected to the illumination control unit 121 (IC chip) of the lighting element 120 (LED-mounted mirror) via the elevation control unit 111 of the elevation device 101, thereby providing a control of the light emission, the light OFF, the illuminance, and the colors of the individual LED chips.

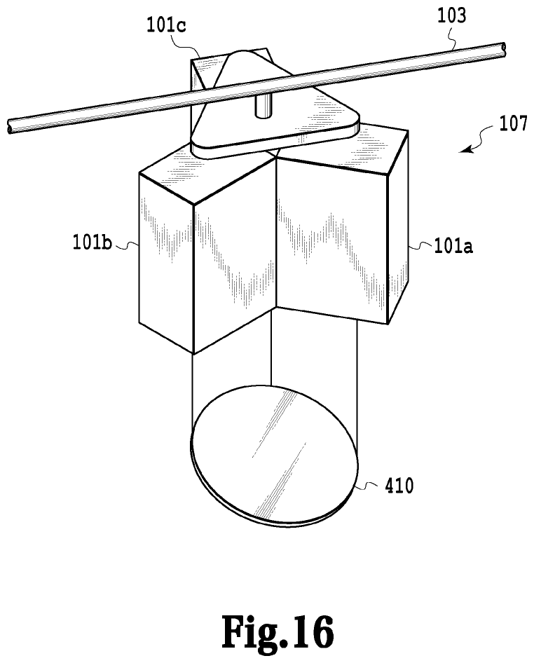

FIG. 16 illustrates the relation between the mirror and the LED-mounted mirror and the elevation device. The elevation device 107 in which the three elevation devices 101a-101c are attached to the beam of a truss structure is used to elevate one mirror 410 or the LED-mounted mirror 420. Thus, the mirror 410 and LED-mounted mirror 420 can be moved in the up-and-down direction while being maintained in the horizontal direction or can be moved in the up-and-down direction as shown in FIG. 16 while arbitrarily changing the normal line direction of the mirror to an arbitrary direction.

(Led Bar)

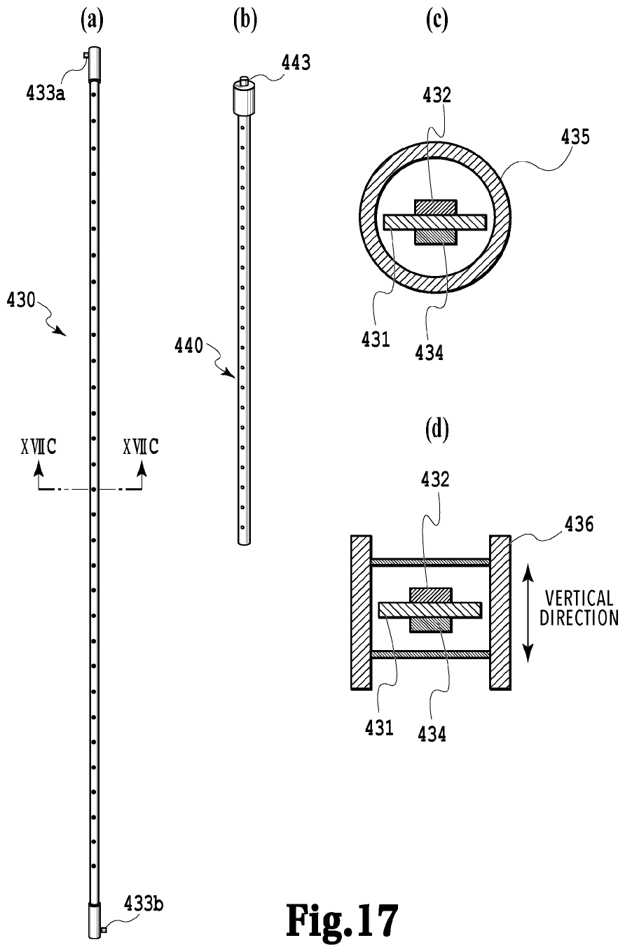

FIGS. 17(a) to 17(d) illustrate the LED bar as a lighting element as a to-be-lifted object. FIG. 17(a) illustrates the appearance of an LED bar 430. FIG. 17(c) is a cross-sectional view illustrating the LED bar 430. The LED bar 430 is configured so that a transparent acrylic pipe 435 includes a mounting board 431. Both ends of the pipe 435 are attached to connectors 433a and 433b. The LED bar 430 has a length ranging from 30 cm to about 2 m. The surface of the mounting board 431 is attached with an LED chip 432. The back face of the board and the back side of the LED chip 432 have an IC chip 434 functioning as an illumination control unit and a power source. The back face of the mounting board 431 also can have not only the IC chip 434 but also an LED chip.

FIG. 17(d) is a cross-sectional view illustrating another embodiment of the LED bar 430. When both ends of the LED bar 430 are suspended from the elevation device, the long bar is deflected in the vertical direction. To prevent this, a pipe 436 is used that is made of steel and that has an H-shaped cross section for example. In order to prevent the deflection, a vertical member is allowed to have a larger thickness than that of a horizontal member.

The LED bar 430 is elevated by two reel wires among which one reel wire is used as a control line and a power line and the other reel wire is used as two pairs of power lines, thereby providing an increased supply of electric power to the LED chip.

FIG. 17(b) illustrates the appearance of an LED bar 440 and shows a configuration in which a connector 443 is provided only at one position. The LED bar 440 receives power supplied from one elevation device only and thus requires LED chips half-reduced than in the case of the LED bar 430. Specifically, when LED bar 440 and the LED bar 430 have the same length, LED chips can be mounted on the LED bar 430 with an increased density.

As a countermeasure against heat caused by densely-mounted LED chips, holes may be formed in the pipes 435 and 436. The number of the heat dissipation holes is set so that the bar deflection is prevented from being increased by moving upwardly and downwardly the bar to provide air flowing through the pipes 435 and 436.

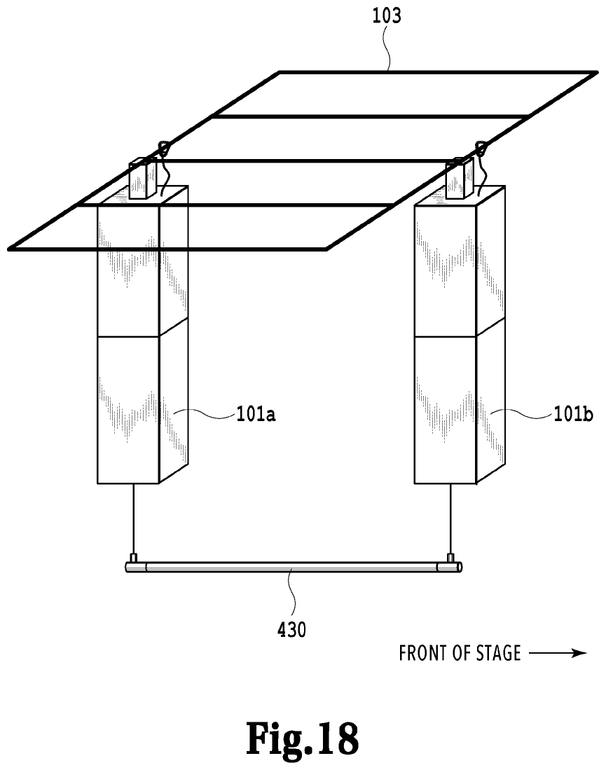

FIG. 18 illustrates the relation between the LED bar and the elevation device. The LED bar 430 is moved in the up-and-down direction using one pair of two elevation devices 101a-101b. The LED bar 430 is suspended in a direction parallel to the depth of the stage. Thus, the LED bar 430 can be moved in the up-and-down direction while being maintained in the horizontal direction or while having a different inclination angle to thereby allow viewers in front of the stage to see the light from the LED chips 432 mounted on the surface and the back face of the mounting board 431. In the three-dimensional stage representation system shown in FIG. 1, the controller 104 is communicatively connected to the illumination control unit 121 (the IC chip 434) of the lighting element 120 (the LED bars 430 and 440) via the elevation control unit 111 of the elevation device 101, thereby providing a control of the light emission, the light OFF, the illuminance, and the colors of the individual LED chips.

(Display Panel)

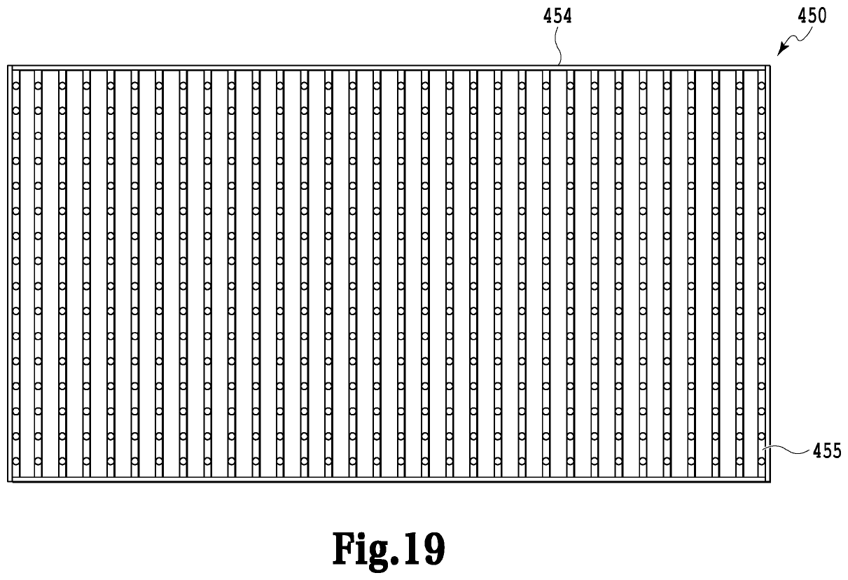

FIG. 19 illustrates a display panel of lighting elements as a to-be-lifted object. The display panel 450 has four corners formed by a frame 454 composed of aluminium steel for example. In this embodiment, the frame 454 has a size of about 1 m×2 m. A plurality of LED bars 455 are provided from the upper side to the lower side of the frame 454 with an interval thereamong. The LED bar 455 has the same body as that of the LED bar shown in FIG. 17.

The four corners of the frame 454 are attached with connectors (that are connected to the back face in the drawing). The frame 454 is moved in the up-and-down direction using one pair of four elevation devices. Thus, the display panel 450 can be moved in the up-and-down direction while having a different inclination angle. In the three-dimensional stage representation system shown in FIG. 1, the controller 104 is communicatively connected to the illumination control unit 121 (IC chip) of the lighting element 120 (the display panel 450) via the elevation control unit 111 of the elevation device 101, thereby providing a control of the light emission, the light OFF, the illuminance, and the colors of the individual LED chips. Specifically, the display panel 450 can display an arbitrary image as in a liquid crystal display or an electric noticeboard.

(Led Crystal)

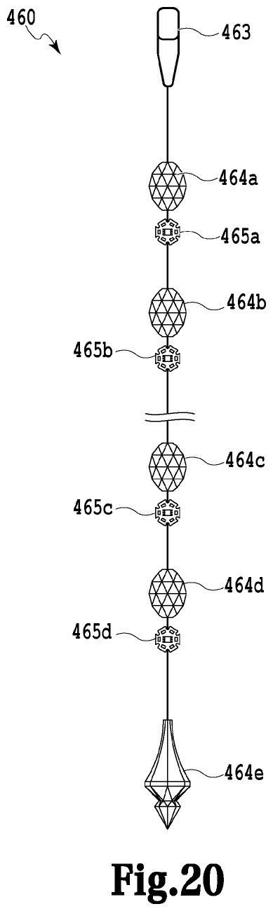

FIG. 20 illustrates the LED crystal as a lighting element as a to-be-lifted object. The LED crystal 460 is a line part obtained by attaching a plurality of crystal or acrylic cut glass pieces 464a-464e and a plurality of LED balls 465a-465d shown in FIG. 13 to a series of cables.

In the three-dimensional stage representation system shown in FIG. 1, the controller 104 is communicatively connected to the illumination control unit 121 (IC chip) of the lighting element 120 (LED balls 465a-465d) via the elevation control unit 111 of the elevation device 101 to thereby provide a control of the light emission, the light OFF, the illuminance, and the colors of the individual LED chips.

(Led Earth)

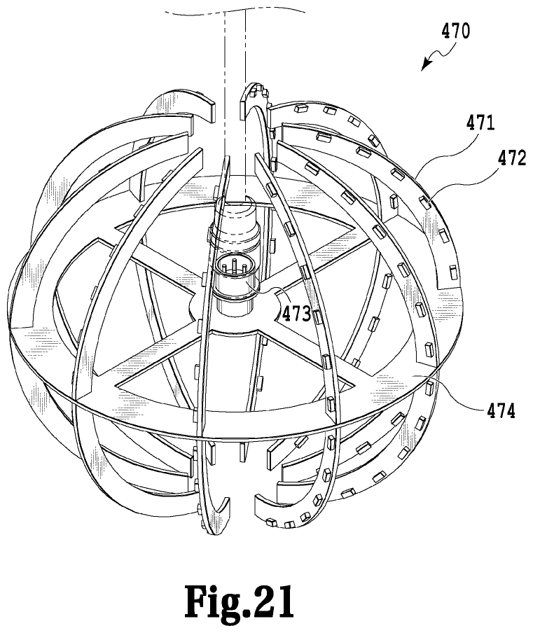

FIG. 21 illustrates the LED earth of the lighting element as a to-be-lifted object. The LED earth 470 has a spherical appearance obtained by attaching a plurality of half circular arc-like mounting boards 471 to a frame 474. The respective boards have surfaces having thereon LED chips 472. The back face of the board and the back side of the LED chip 472 have IC chips functioning as an illumination control unit and a power source. The LED chip 472 is a horizontally-placed LED in which light is emitted from a side face when the LED chip 472 is mounted on the board.

The back face of the mounting board 421 also can include not only an IC chip but also an LED chip. A power line connected to an illumination control unit and a control line connected to a power source are connected to the reel wire via a connector 473.

In the three-dimensional stage representation system shown in FIG. 1, the controller 104 is communicatively connected to the illumination control unit 121 (IC chip) of the lighting element 120 (LED earth) via the elevation control unit 111 of the elevation device 101 to thereby provide a control of the light emission, the light OFF, the illuminance, and the colors of the individual LED chips.

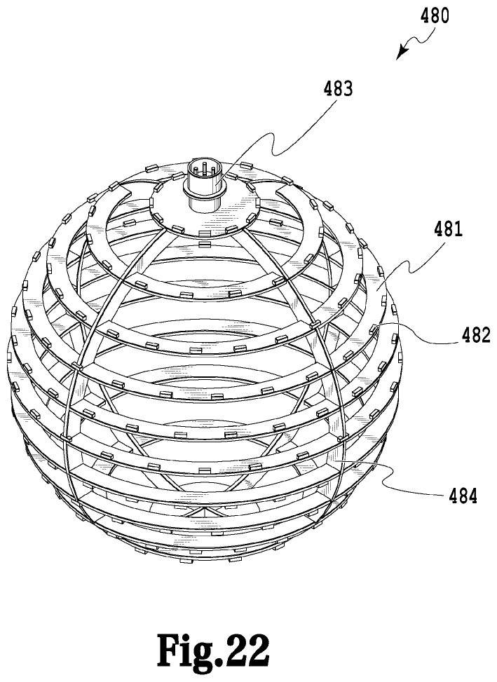

FIG. 22 illustrates the LED earth according to another embodiment. The LED earth 480 has a spherical appearance obtained by attaching a plurality of doughnut-like mounting boards 481 having different diameters to a frame 484. In the LED earth of FIG. 21, the LED chips are longitudinally arranged. In the LED earth of FIG. 22, the LED chips 482 are arranged along the latitude. The LED chip 482 is also a horizontally-placed LED.

The LED ball shown in FIG. 13 appears as a point light source for viewers watching the stage while the LED earth appears for such viewers as a light-emitting sphere having a very-high illuminance.

(Led Balloon)

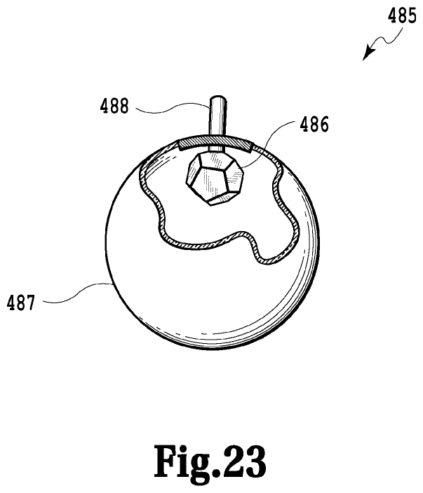

FIG. 23 illustrates an LED balloon as a lighting element as a to-be-lifted object. The LED balloon 485 is a lighting element obtained by attaching an LED ball 486 connected to a connector 488 (the LED ball shown in FIG. 13) to the interior of a balloon case 487. In order to achieve a light weight, the balloon case 487 is a transparent, semitransparent, or colored light-transmitting member and is made of silicon material for example. Although the balloon case 487 is shown as a spherical shape, the balloon case 487 also can be formed to have various shapes such as a box or egg-like shape.

The LED ball shown in FIG. 13 appears as a point light source for viewers watching the stage while the LED balloon appears for such viewers as a light-emitting sphere having a relatively-large size similar to a lamp. However, some balloon cases 487 undesirably cause a lower illuminance than in the case of the LED earth or the LED ball. Thus, limited representation methods may be used.

(Led Triangle)

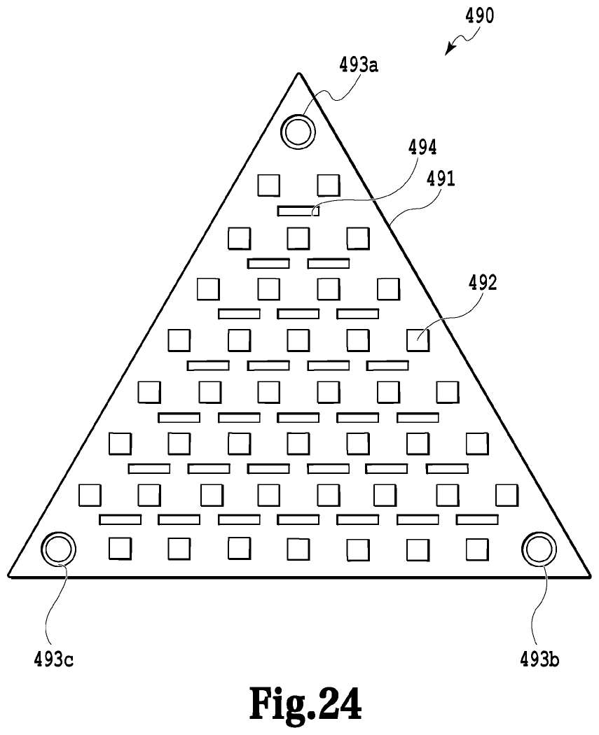

FIG. 24 illustrates an LED triangle as a lighting element as a to-be-lifted object. The LED triangle 490 is obtained by attaching a plurality of LED chips 492 to the surface of an equilateral triangle-shaped mounting board 491. The mounting board 491 has a size for which one side is about 60 cm. The plurality of LED chips 492 are arranged on the mounting board 491 with an equal interval so that a plurality of openings 494 are provided thereamong. When a flat plate such as the LED triangle is moved by the elevation device in the up-and-down direction at a high speed while maintained in the horizontal direction, the plate is stabilized by the air resistance and is prevented from having a vertical motion. When the LED triangle is moved in the up-and-down direction while being inclined, a dynamic lift occurs, which stabilizes the LED triangle to prevent the LED triangle from having a vertical motion. To realize this, the mounting board 491 includes a plurality of openings 494 with an equal interval so as to reduce the air resistance.

The back face of the board and the back side of the LED chip 492 have IC chips functioning as an illumination control unit and a power source. The back face of the mounting board 421 also can include not only an IC chip but also an LED chip. The control line connected to the illumination control unit and the power line connected to the power source are connected to the reel wire via connectors 493a-493c.

The LED triangle may be connected to the elevation device by substituting the mirror 410 shown in FIG. 16 with the LED triangle 490. One LED triangle 490 is elevated using one pair of three elevation devices 101a-101c. Thus, the LED triangle 490 can be moved in the up-and-down direction in the normal line direction of the mounting board while arbitrarily having a different direction.

The LED triangle 490 is elevated by three reel wires among which one reel wire is used as a control line and a power line and the other two reel wires are used as two pairs of power lines, thereby increasing the supply of electric power to the LED chips.

In the three-dimensional stage representation system shown in FIG. 1, the controller 104 is communicatively connected to the illumination control unit 121 (IC chip) of the lighting element 120 (LED triangle) via the elevation control unit 111 of the elevation device 101 to thereby provide a control of the light emission, the light OFF, the illuminance, and the colors of the individual LED chips.

[4. Three-Dimensional Stage Representation Method]

(Basic Control of the Elevation Device and the to-be-Lifted Object)

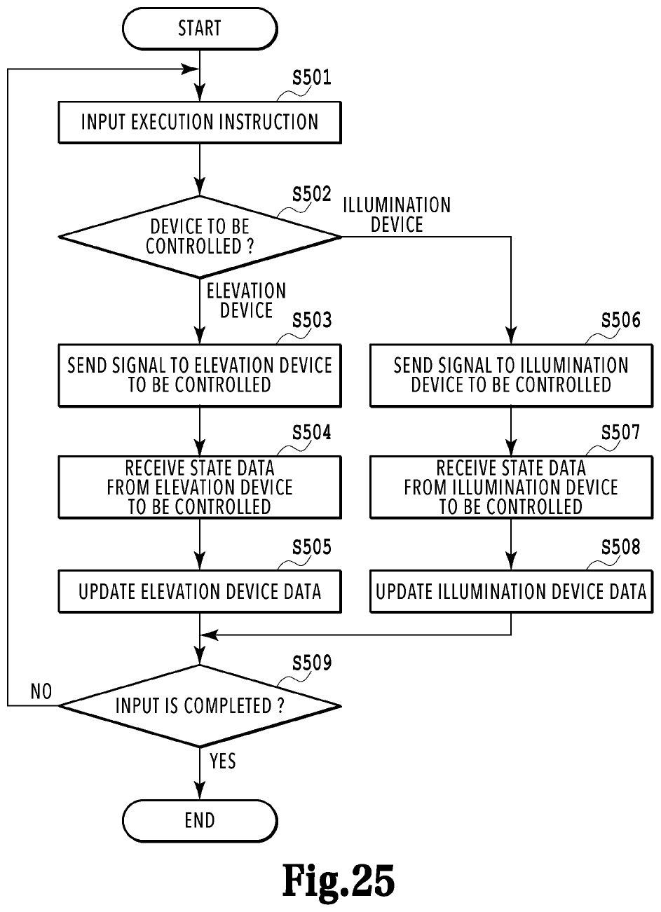

FIG. 25 is a flow diagram to illustrate the basic control of the elevation device and the to-be-lifted object. With reference to FIGS. 1 and 2, the following section will describe the basic flow of allowing the controller 104 to control the elevation device 101 and the lighting element 120 based on a wired control method. Upon receiving an execution instruction from a control program prepared based on a procedure of a predetermined representation method or an execution instruction from the input/output unit 142 based on an external input from an operator (Step S501), the device control unit 141 identifies a device to be controlled (Step S502) and generates an instruction signal. The instruction signal is generated by referring to representation data, the elevation device data 145, and the illumination device data 146 stored in the memory 144. The instruction signal includes a position signal for determining the position of the to-be-lifted object and a function control signal for controlling the function of the to-be-lifted object (including a dimming signal for determining the light emission state of a lighting element) for example.

For example, upon receiving an execution instruction to move the position of a specific lighting element 120 to a position lower than the elevation device by a distance of the length L=3 m of the reel wire, then an instruction signal is sent to the elevation control unit 111 of the elevation device 101 to be controlled (Step S503). The elevation control unit 111 of the elevation device 101 controls the motor unit 112 to lower the lighting element 120 while monitoring the length of the reel wire calculated by the counter unit 115. When the length of the reel wire calculated by the counter unit 115 reaches 3 m, then the elevation control unit 111 stops the rotation of the reel unit 113 and sends, to the device control unit 141, state data showing that the lowering of the lighting element 120 to the predetermined position is completed (Step S504).

The device control unit 141 stores the state data (the position of the lighting element 120) in the elevation device data 145 of the memory 144 or updates the elevation device data 145 registered in advance (Step S505).

For example, upon receiving an execution instruction to light a specific lighting element 120 with predetermined brightness and color, then an instruction signal is sent via the elevation control unit 111 of the elevation device 101 to be controlled to the illumination control unit 121 of the lighting element 120 (Step S506). The illumination control unit 121 of the lighting element 120 controls the LED unit 122 to light a predetermined LED. The illumination control unit 121 sends, to the device control unit 141, state data showing that the lighting operation is completed (Step S507).

The device control unit 141 stores, in the illumination device data 146 of the memory 144, the state data received via the elevation device 101 or updates the illumination device data 146 registered in advance (Step S508). Execution instructions are sequentially executed until no more execution instruction is received from the control program (Step S509).

The controller 104 sequentially controls the elevation device 101 and the lighting element 120 to set, based on the predetermined procedure of the representation method, the positions and light emission states of the individual lighting elements with time. In this manner, to-be-lifted objects such as a plurality of lighting elements are controlled in a synchronized manner to provide a three-dimensional stage representation on the stage using illumination. The following section will describe a specific representation method.

(Object Generation)

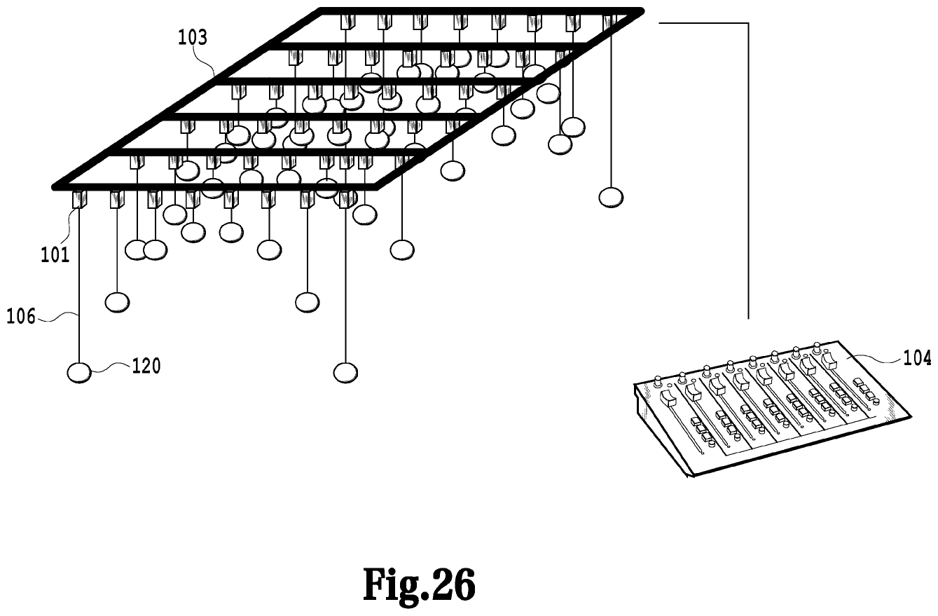

With reference to FIG. 26, the following section will describe the three-dimensional stage representation method using an LED ball according to one embodiment of the present invention. The suspension baton 103 of the three-dimensional stage representation system of this embodiment has a well curb-like shape and is attached with a plurality of the elevation devices 101 formed as the lighting element 120 with an equal interval that are used to suspend the LED balls shown in FIG. 13. Depending on the size of the stage, elevation devices and LED balls are suspended in the quantity ranging from about 5×20=100 to about 20×40=800.

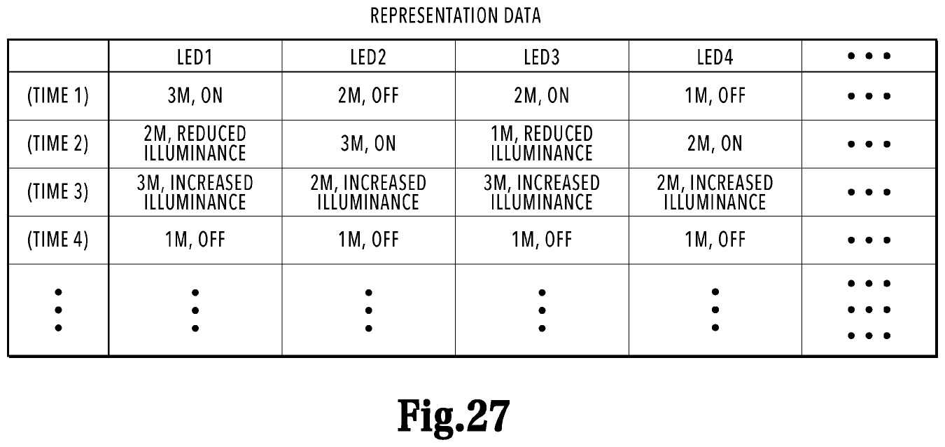

The device control unit 141 of the controller 104 have control programs and the representation data shown in FIG. 27 stored in the memory 144. A specific lighting element (LED ball) LED 1 has, at the time 1, the reel wire 106 having the length L=3 m and an entire-lighting state and has, at the time 2, the reel wire 106 having the length L=2 m and a reduced illuminance. Similarly, the lifting/lowering state and the lighting state of all LED balls are specified in a time-series manner. The device control unit 141 generates, upon executing the control program, the elevation device data 145 and the illumination device data 146 based on the representation data to generate an instruction signal based on the time of the representation data to send the instruction signal to the elevation device 101 and the lighting element 120.

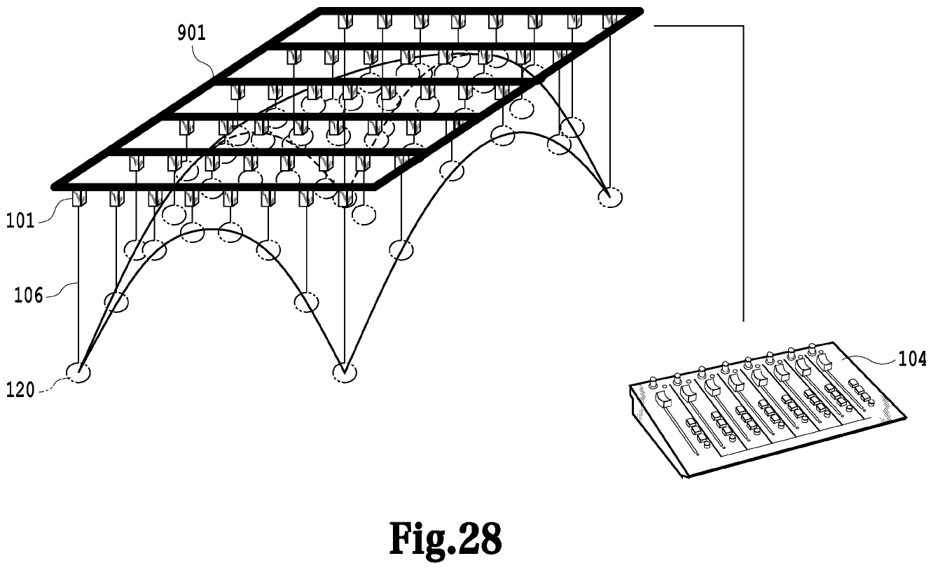

As shown in FIG. 28, the respective lighting elements 120 are allowed to move in the up-and-down direction to provide light spots formed by the LED balls scattered in a three-dimensional space. When these light spots in the stage are seen from viewers, these light spots form an arbitrary-shaped object (e.g., in a chandelier-like manner). These light spots can be used to express not only a still object but also a moving object by moving the LED balls in the up-and-down direction in a time-series manner (in a manner like a waving and lighting carpet).

The LED ball shown in FIG. 13 may be substituted with the LED earth shown in FIGS. 21 and 22 or the LED balloon shown in FIG. 23 that may be suspended for representation. When being seen from viewers in front of the stage, the LED ball is visually recognized as one light spot. In contrast with this, the LED earth or the LED balloon is visually recognized as a lighting sphere having a relatively-large size, thus providing a representation different from that provided by an object generation. By controlling the individual LED chips of the LED earth, two hemispheres having two different colors can be connected to express a lighting sphere or can provide a mirror ball-like effect.

(Mirror Representation)

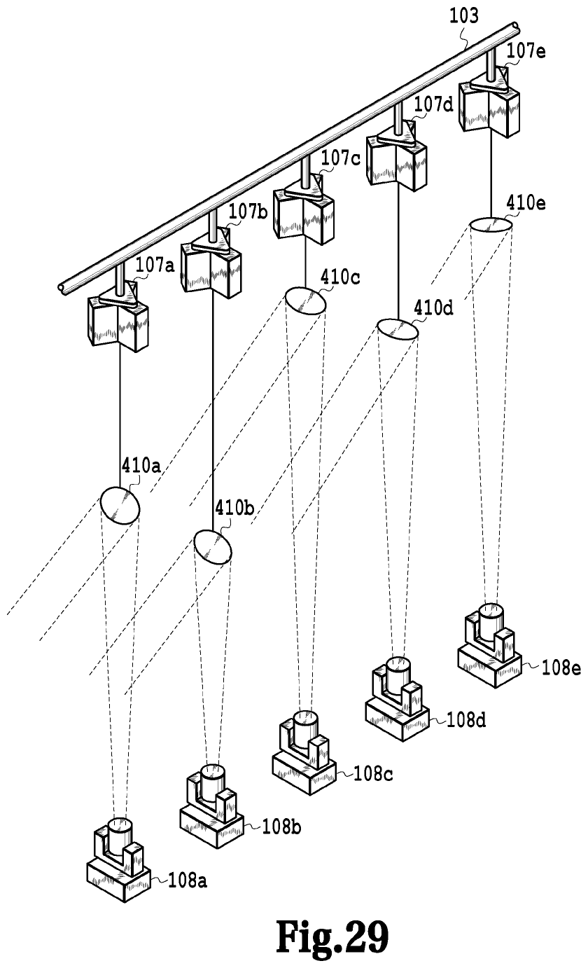

With reference to FIGS. 29-33, the following section will describe the three-dimensional stage representation method using a mirror according to one embodiment of the present invention.

FIG. 29 illustrates Illustrative Embodiment 1 of the three-dimensional stage representation method using the mirror. Complex elevation devices 107a-107e have the mirrors 410a-410e shown in FIG. 14 suspended therefrom, respectively (although one mirror is suspended from three reel wires, the three reel wires are simply represented as one reel wire in FIG. 29 and FIG. 30 to FIG. 33). Light projectors 108a-108e are provided just under the complex elevation devices in a manner such that the light projectors 108a-108e are provided on or buried in the stage at positions just under the mirrors.

The light projectors can be a spot light obtained by collecting light from a light source such as an LED or an electric-light bulb via a lens for example to convert the light to parallel light or laser light projector for example. The mirror and the light projector are controlled in a synchronized manner by the controller 104 sending a control signal to a control console of the illumination device. Such a synchronized control also may be provided by a common control console functioning both as the controller 104 and the control console of the illumination device.

For example, the controller (not shown in FIG. 29 to FIG. 33) controls each elevation device of the complex elevation device 107a to set the mirror 410a at an arbitrary height and an arbitrary angle. When light beam is emitted from the light projector 108a to the mirror 410a, the light beam is reflected at the set angle as shown in the drawing. This is recognized by viewers in front of the stage as if spot light is emitted from one point in the air in the stage (mirror). Specifically, the light is actually emitted from beneath the stage but the audience looking at the stage recognizes this light as being emitted from the mirror. Although FIG. 29 shows a stationary state only, light beams may be emitted from various positions at various angles by changing, in accordance with the instruction from the controller, the positions of the respective mirrors in the up-and-down direction and the angles in a time-series manner.

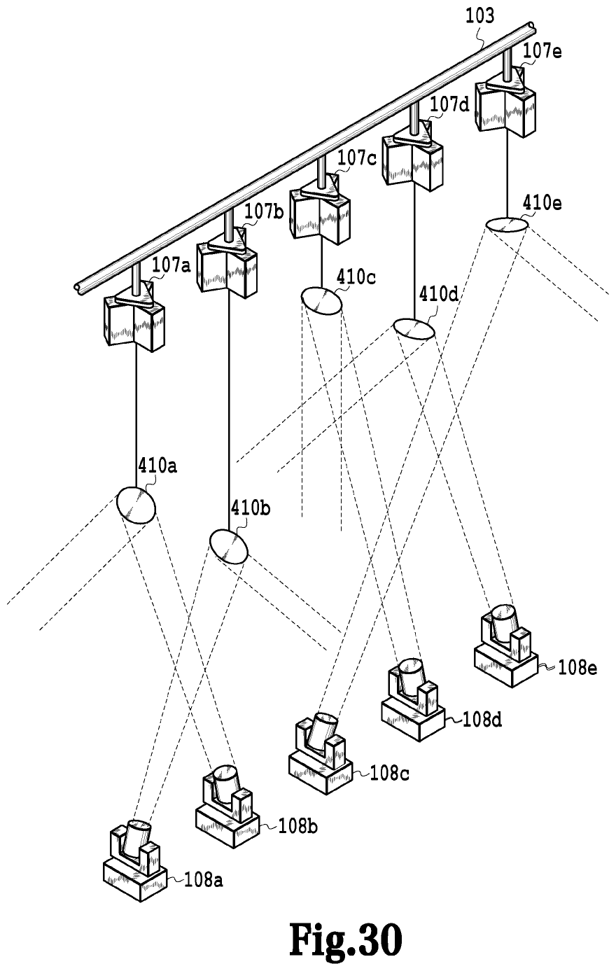

FIG. 30 illustrates Illustrative Embodiment 2 of the three-dimensional stage representation method using mirrors. In Illustrative Embodiment 1, a light beam was emitted from the light projector 108a provided just under the mirror 410a. Specifically, the light projector 108a and the mirror 410a have a one-to-one correspondence. In Illustrative Embodiment 2, mirrors and light projectors have random correspondences. For example, the mirror 410a receives a light beam emitted from the light projector 108b next to the one just under the mirror 410a. Mirrors are suspended from three elevation devices and thus have a limitation on an angle at which the mirrors can be set. Thus, when only light beams from light projectors just under the respective mirrors are used, the light beams have limited reflective angles. To solve this, light beams are emitted to mirrors not only from light projectors just under the respective mirrors but also light projectors not under the respective mirrors with various angles, thereby providing a wider range within which the reflective angles of the light beam can be set.

In Illustrative Embodiment 2, a direction along which light is emitted from the light projector 108 must be controlled depending on the move of the mirror 410. In order to control the former and the latter in a synchronized manner, a control is desirably provided from a common control console functioning both as the controller 104 and the control console of the illumination device.

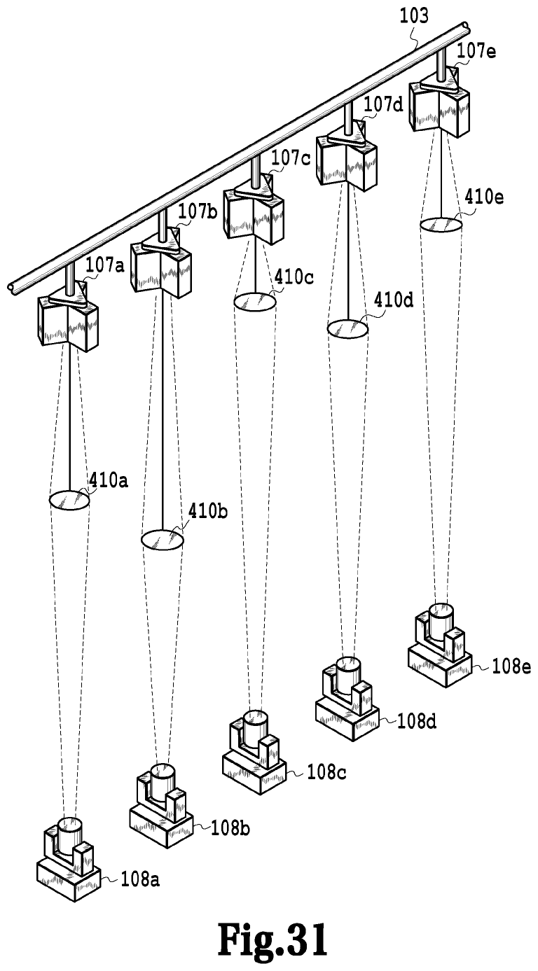

FIG. 31 illustrates Illustrative Embodiment 3 of the three-dimensional stage representation method using mirrors. In Illustrative Embodiment 3, light projectors are further provided among the three elevation devices of complex the elevation device 107 or at the beam center. The controller controls the respective elevation devices of the complex the elevation device 107a to horizontally set the mirror 410a at an arbitrary height. A light beam is emitted from the light projector 108a to the mirror 410a and another light beam is emitted from the light projector of the complex the elevation device 107a.

By allowing the light beam of the light projector 108a to have a different color from that of light beam from the light projector of the complex the elevation device 107a, these light beams having different colors are visually recognized by viewers in front of the stage as light columns having different colors starting from one point in the air in the stage (mirror). In addition, when the angle of the mirror is changed, the light beams having different colors are reflected in a 180 degree-inverted direction. This is visually recognized by viewers in front of the stage as if spot lights of two colors are simultaneously emitted from one point in the air in the stage (mirror) in opposite directions.

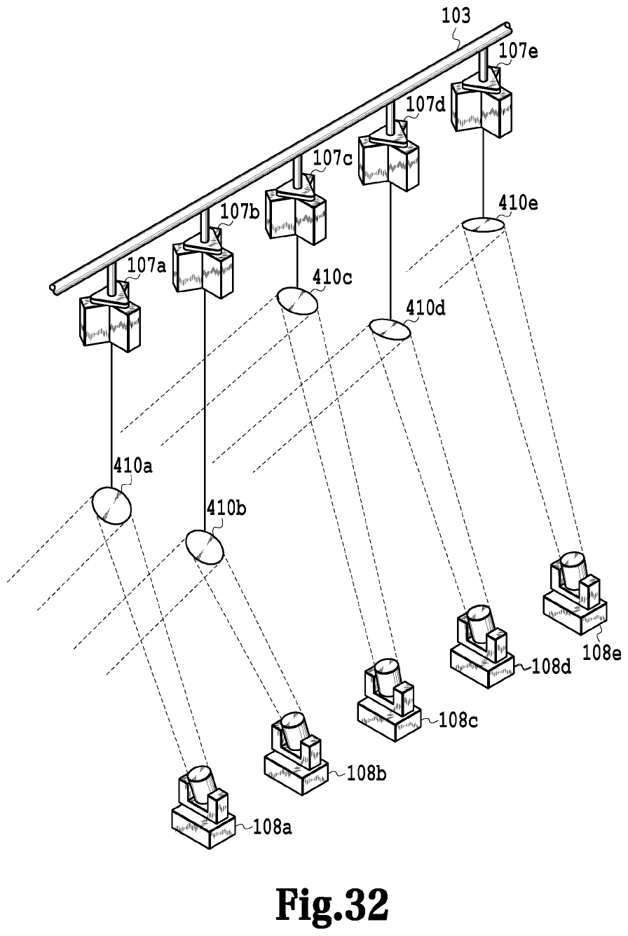

FIG. 32 illustrates Illustrative Embodiment 4 of the three-dimensional stage representation method using mirrors. As shown in Illustrative Embodiments 1-3, there may be a case where the light projector 108a-108e cannot be provided on or buried in the stage at positions just under the mirrors. Illustrative Embodiment 4 provides the light projectors 108a-108e not just under the mirror but along the front side of the stage wing stage so that light beams are emitted to mirrors, respectively. The light projectors also can be provided among seats in the theater, wall faces at sides of the seats, or at the ceiling having a distance from the suspension baton 103 in the stage and light beams can be emitted to mirrors.

Illustrative Embodiment 4 similarly requires the synchronized control of the mirror 410 and light projector 108. Thus, a control is desirably provided from a common control console functioning as both of the controller 104 and the control console of the illumination device.

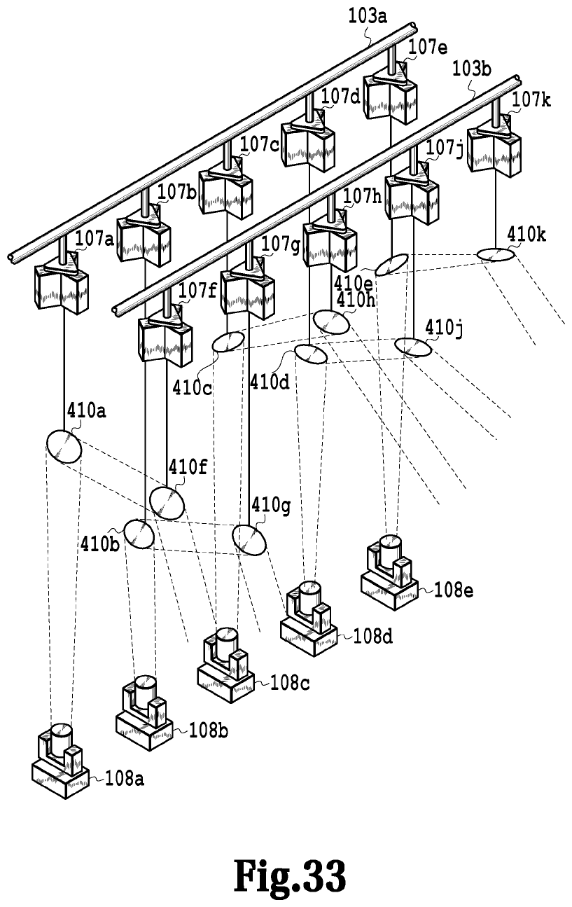

FIG. 33 illustrates Illustrative Embodiment 5 of the three-dimensional stage representation method using mirrors. For example, a controller controls the respective elevation devices of the complex the elevation device 107a to set the mirror 410a at an arbitrary height and an arbitrary angle. The respective elevation devices of the complex the elevation device 107f are also controlled to set the mirror 410f at an arbitrary height and an arbitrary angle. The light beam emitted from the light projector 108a to the mirror 410a is reflected, as shown, by the mirror 410a and is subsequently reflected by the mirror 410f This is recognized by viewers in front of the stage as if the spot light emitted from one point in the air in the stage (the mirror 410a) is subsequently emitted from another one point (the mirror 410f) with a different angle. In this manner, refracted light beams can be generated in various forms.

In Illustrative Embodiments 1-5, an example was shown in which the mirror 410 shown in FIG. 14 was used. The mirror 410 may be substituted with the LED-mounted mirror 420 shown in FIG. 15. A wider range of representations can be provided by using both or any of the light circle by the LED chip 422 mounted on the annular mounting board 421 of the LED-mounted mirror 420 and the light beam from the light projector.

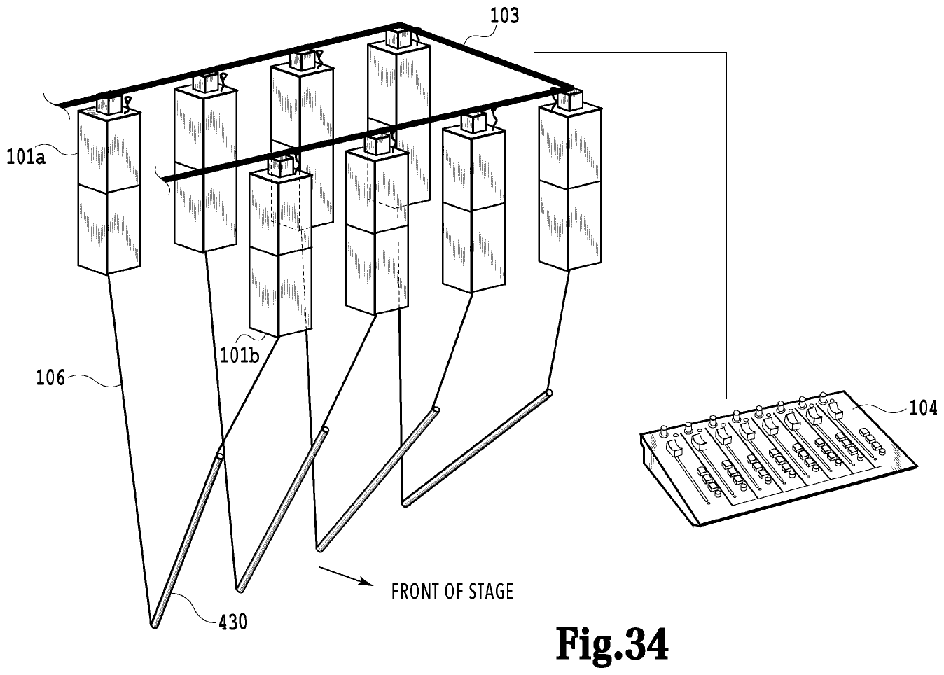

(Bar representation) With reference to FIGS. 34-36, the following section will describe the three-dimensional stage representation method using a bar according to one embodiment of the present invention. FIG. 34 illustrates Illustrative Embodiment 1 of the three-dimensional stage representation method using bars. As shown in FIG. 18, one pair of two elevation devices 101a-101b fixed to the suspension baton 103 has the LED bar 430 shown in FIG. 17(a) suspended therefrom. The LED bar 430 is suspended in a direction parallel to the depth of the stage. For example, the controller 104 controls the respective elevation devices 101a-101b to set the LED bar 430 at an arbitrary height and an arbitrary angle.

The lighting of the LED chips 432 mounted on the top face and the back face of the mounting board 431 of the LED bar 430 can be controlled to move a plurality of the LED bars 430 in the up-and-down direction or with a different angle. This can be visually recognized by viewers in front of the stage as a plurality of light bars flying in the air. An arbitrary-shaped object as in an LED ball also can be formed by controlling the lighting of the individual LEDs of the LED bar 430.

Alternatively, a plurality of the LED bars 430 suspended in a parallel manner can be used in a configuration similar to that of the display panel shown in FIG. 19 to thereby provide a representation by the display panel.

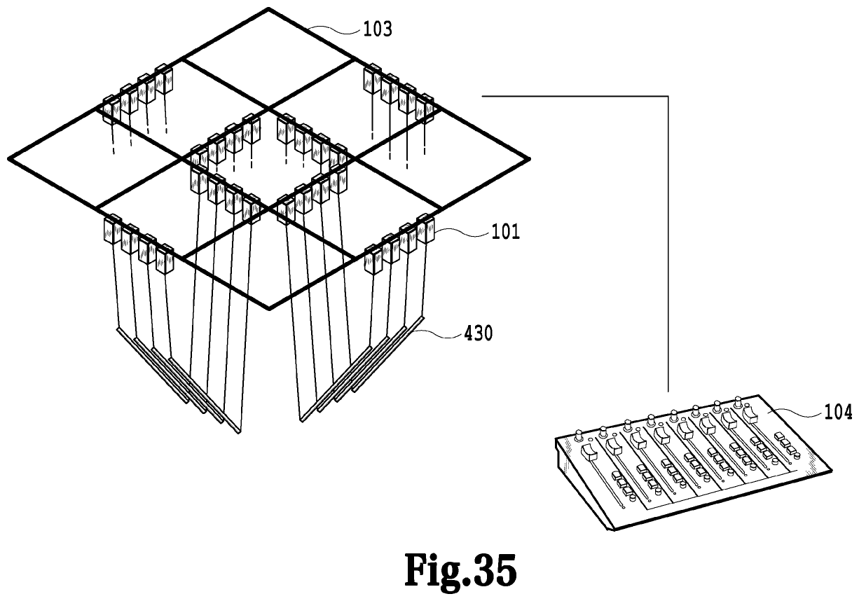

FIG. 35 illustrates Illustrative Embodiment 2 of the three-dimensional stage representation method using bars. In Illustrative Embodiment 1, a plurality of the LED bars 430 are provided at the front side of the stage in a direction parallel to the depth of the stage. In Illustrative Embodiment 2, the suspension baton 103 having a well curb-like shape has four pairs of a plurality of the LED bars 430 shown in FIG. 34 that are provided in the total of four directions of the front side of the stage, both winds of the stage, and the back face of the stage.

The plurality of LED bars 430 are arranged to form a rectangular frame-like shape in four directions. By moving the respective LED bars in the up-and-down direction, an arbitrary-shaped object (e.g., chandelier) can be visually recognized by viewers in front of the stage. By placing a performer at the center of the rectangular frame-like shape, the performer can be surrounded by a represented light curtain.

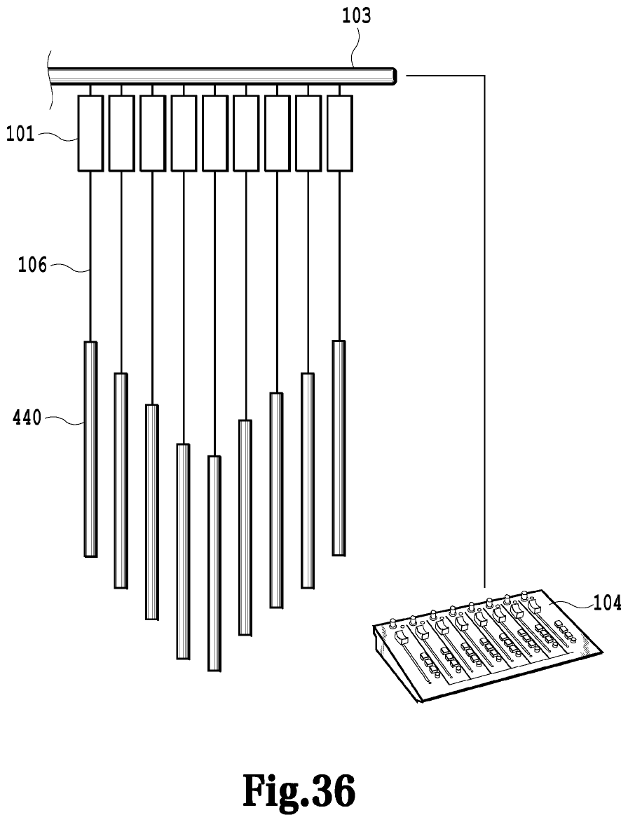

FIG. 36 illustrates Illustrative Embodiment 3 of the three-dimensional stage representation method using bars. In Illustrative Embodiment 2, a plurality of LED bars 440 shown in FIG. 17(b) are suspended. The controller 104 controls the respective elevation devices 101 to thereby provide the representation of a screen-like light curtain. Alternatively, a plurality of the LED bars 440 set to be parallel to one another may provide the representation of a display panel.

In Illustrative Embodiment 2, an example was shown in which the LED bar 440 shown in FIG. 17(b) was used. This may be substituted with the LED crystal 460 shown in FIG. 20. A plurality of LED balls 465 can be used to provide a representation similar to that using the LED bar 440 and a wider range of representations can be provided by using the reflection by a plurality of cut glass pieces 464.

(Display Panel Representation)

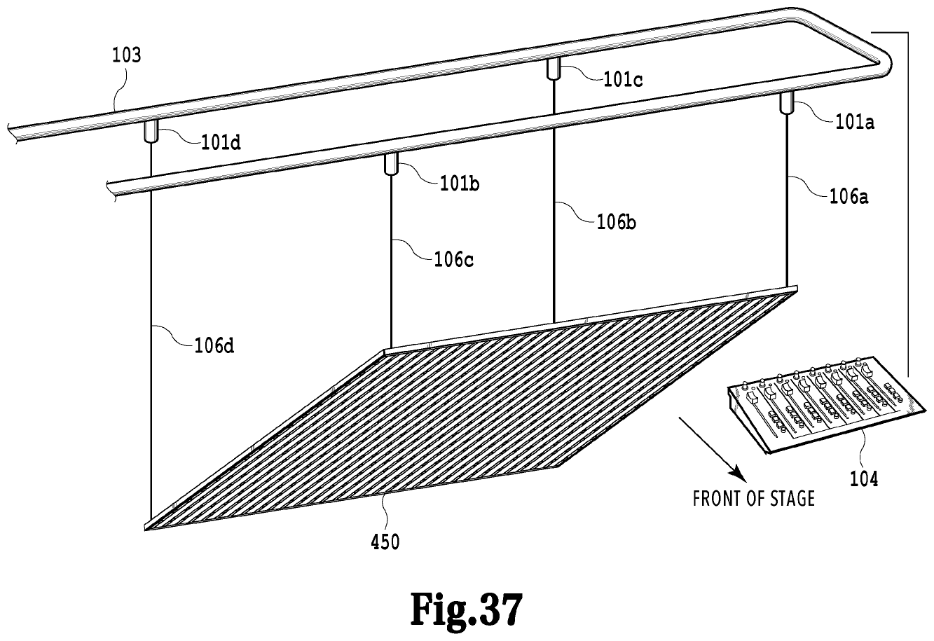

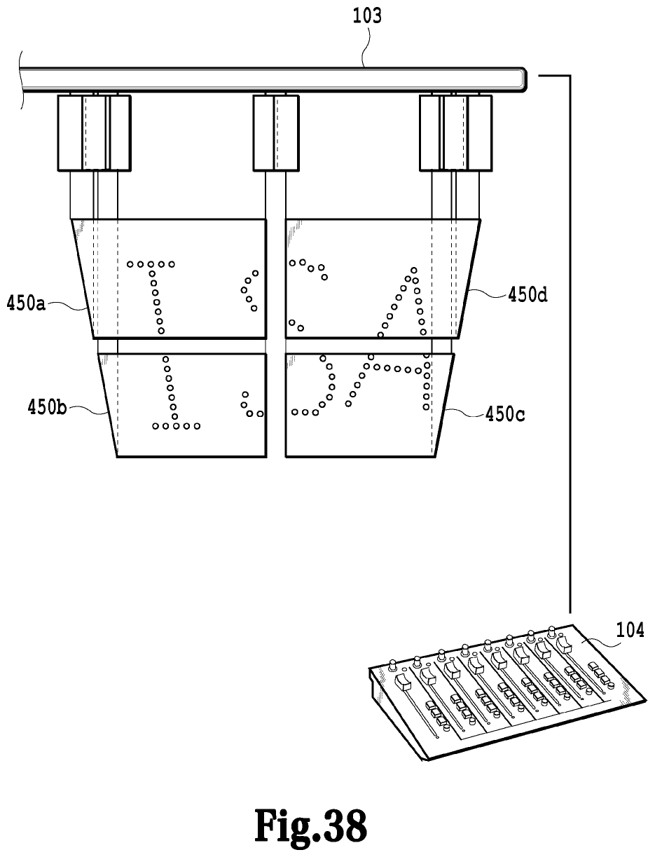

With reference to FIGS. 37-38, the following section will describe the three-dimensional stage representation method using a display panel according to one embodiment of the present invention. FIG. 37 illustrates Illustrative Embodiment 1 of the three-dimensional stage representation method using a display panel. The four elevation devices 101a-101d fixed to the suspension baton 103 have the display panel 450 shown in FIG. 19 suspended therefrom. For example, the controller 104 provides a control of the light emission, the light OFF, the illuminance, and the colors of the individual LED chips of the display panel 450, thereby realizing an image displayed as in a liquid crystal display or an electric noticeboard.

Furthermore, the angle of the display panel 450 can be arbitrarily set. Thus, the normal line of the display panel 450 can be oriented in a direction to specific seats in front of the stage to thereby allow a viewer sitting in the seats in this direction to look at the image of the display panel 450 displayed in front of the viewers. Furthermore, the respective elevation devices 101a-101d can be controlled to change the position and angle of the display panel 450 to thereby move a two-dimensional object displayed on the display panel 450 not only on the plane of the display panel 450 but also in a three-dimensional space.

As shown in FIG. 19, the display panel 450 has a plurality of LED bars 455 provided with an interval. The LED bars use transparent acrylic pipes and thus can provide a transparent display panel. When the respective LEDs of the display panel 450 are all lighted to provide a sufficient light quantity, then viewers in front of the stage cannot see what is placed behind the display panel (e.g., an artist). If the light from the respective LEDs of the display panel 450 are turned OFF, the artist behind the display panel can be visually recognized by the viewers. Thus, a light curtain can be represented.

FIG. 38 illustrates Illustrative Embodiment 2 of the three-dimensional stage representation method using display panels. Four display panels 450a-450d can be used to increase the display region provided by the display panels. In Illustrative Embodiment 2, the individual display panels can have different angles to thereby provide an image effect with a depth feel. Alternatively, the use of the plurality of display panels to represent the background of the stage can provide a swift change of images required for the respective scenes, thus providing a substitute for a large-scale stage set.

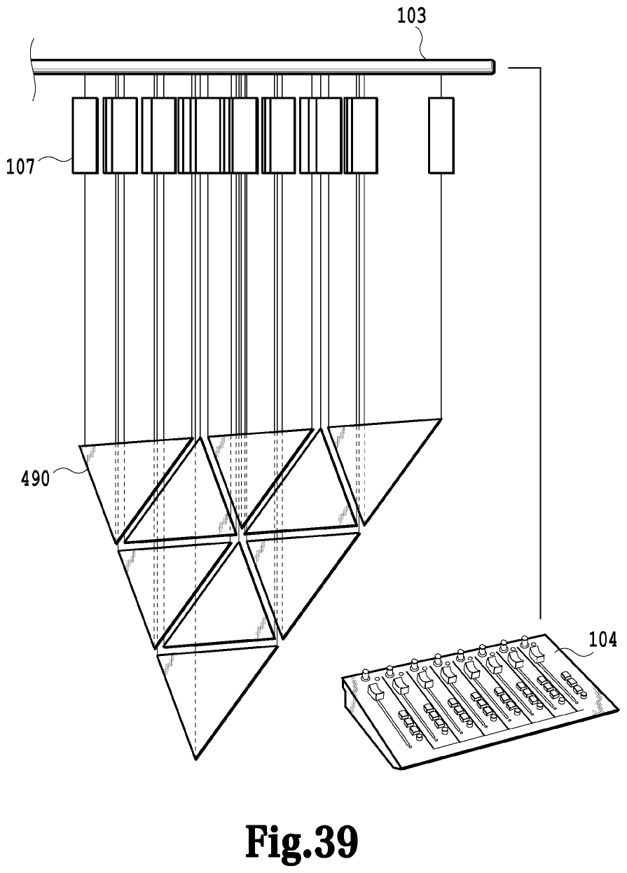

With reference to FIG. 39, the following section will describe the three-dimensional stage representation method using LED triangles according to one embodiment of the present invention. A complex the elevation device 107 has the LED triangles 490 shown in FIG. 24 suspended therefrom, respectively. A plurality of complex elevation devices 107 fixed to the suspension baton 103 are used so that a plane truss is configured by the LED triangles 490. For example, the controller 104 provides a control of the light emission, the light OFF, the illuminance, and the colors of the individual LED chips of the LED triangles 490.

The LED ball 400 shown in FIG. 13 displays a light spot. The display panel 450 shown in FIG. 19 displays many light spots on a two-dimensional plane having a size of about 1 m×2 m. In contrast with this, the LED triangle 490 has an equilateral triangle-shaped mounting board 491 for which one side is 60 cm, thus providing dozens of light spots. Thus, an object can be generated as in the representation using an LED ball and an image also can be displayed as in the representation using a display panel and a liquid crystal display.

In addition, when compared with the LED ball 400 shown in FIG. 13 and the display panel shown in FIG. 19, a significantly-increased number of LED chips can be placed within a fixed space. Thus, a brighter representation and a more minute object and display can be realized.

An exchange of a to-be-lifted object during the presentation on the stage (e.g., intermission) is difficult to achieve in an actual case. Thus, the use of the LED triangle 490 can provide a representation providing both of the LED ball 400 and the display panel 450, thus eliminating the need to exchange to-be-lifted objects.

[5. Other applications] In an embodiment, a three-dimensional stage representation has been illustratively described that uses the light emitted from a lighting element in a theater, a concert hall, or a television studio for example. The elevation device of this embodiment can have not only a plurality of lighting elements but also acoustic machinery such as a speaker, stage properties, or a stage set for example suspended therefrom to independently elevate them. Thus, as has been descried in the example of a mirror in this embodiment, various representations can be provided by combining lighting elements with various to-be-lifted objects to provide combinations of optical three-dimensional stage representations.

### REFERENCE SIGNS LIST

103 Suspension baton
106, 306, 336, 366 Reel wire
107 Complex elevation device
108 Light projector
120 Lighting element
217, 224, 247 Antenna
300, 330, 360 Elevation device
301, 331, 361 Housing
302, 332, 362 Electric motor
303, 333, 363 Reel
304, 334, 364 Attaching part
305, 335, 365 Attaching hook
307, 337, 367 Guide ring
308, 338, 368 Guide screw
309 Guide rod
310, 340, 370, 403, 413, 423, 433, 443, 463, 473, 483, 488, 493 Connector
341, 342, 346, 371, 372 Pulley
313, 343, 373, 381, 383, 385, 389 Column
344, 374 Reeling guide
345 Guide block
347 Reel wire fixing part
348, 378 Reset switch
375 Upper support plate
376 Lower support plate
377, 393 Bearing
382 Counter support plate
384 Upper motor support plate
386 Lower motor support plate
387 Coupling
388 Reel wire connector support plate
390 Cord wheel
391 Detection circuit
392 Connection board
400, 465, 486 LED ball
401, 421, 431, 471, 481, 491 Mounting board
402, 422, 432, 472, 482, 492 LED chip
410 Mirror
414, 424 Double face mirror
415 Suspension line
416 Reset plate
420 LED-mounted mirror
430, 440, 455 LED bar
434 IC chip
435, 436 Pipe
450 Display panel
454, 474, 484 Frame
460 LED crystal
464 Cut glass
470, 480 LED earth
485 LED balloon
487 Balloon case
490 LED triangle
494 Opening

1. (canceled)

2. A stage representation system for providing a stage representation by changing light in at least two different directions, comprising:
one or more elevation device(s) elevated under control of a controller, wherein each of the one or more elevation device(s) suspends downwardly a mirror connected thereto via a reel wire and the mirror has a double face mirror including a first face and a second face;
a first light projector for emitting first light to the first face under control of the controller and the first light is reflected from the first face; and
a second light projector for emitting second light to the second face under control of the controller and the second light is reflected from the second face in a direction opposite to that of the first light,
wherein the controller elevates the one or more elevation device(s) thereby changing height of the mirror to change lengths of the reflected first light and the reflected second light.

3. The stage representation system according to claim 2, wherein the controller elevates the one or more elevation device(s) thereby changing angle of the mirror to change directions of the reflected first light and the reflected second light.

4. The stage representation system according to claim 2, wherein the controller controls the light emission, the light OFF, the illuminance, and/or the color of the first light and controls the light emission, the light OFF, the illuminance, and/or the color of the second light.

5. The stage representation system according to claim 2, wherein the first face includes lighting elements and the lighting elements emit third light.

6. The stage representation system according to claim 2, wherein the controller executes a control program to control, based on predetermined representation data, the one or more elevation device(s), the first light projector, and the second light projector.

7. A stage representation system for providing a stage representation by changing light in at least two different directions, comprising:
a first group of one or more elevation device(s) moved in an up-and-down direction under control of a controller, each of the first group of the elevation devices suspends downwardly a first mirror connected thereto via a reel wire;
a second group of one or more elevation device(s) moved in an up-and-down direction under control of the controller, each of the second group of the elevation devices suspends downwardly a second mirror connected thereto via a reel wire; and
a light projector for emitting light to the first mirror under control of the controller and the light is reflected from the first mirror in a first direction,
wherein the controller elevates the first group of the elevation devices thereby changing height of the first mirror, and elevates the second group of the elevation devices in synchronization with the height of the first mirror thereby changing height of the second mirror and light reflected from the first mirror is reflected from the second mirror in a second direction.

8. The stage representation system according to claim 7, wherein the controller elevates any of the first group of the elevation devices thereby changing angle of the first mirror, and elevates, in synchronization with the angle of the first mirror, any of the second group of the elevation devices thereby changing angle of the second mirror.

9. The stage representation system according to claim 7, wherein the controller controls the light emission, the light OFF, the illuminance, and/or the colors of the light.

10. The stage representation system according to claim 7, wherein the first mirror includes first lighting elements and the first lighting elements emit third light and the second mirror includes a second lighting elements and the second lighting elements emit fourth light.

11. The stage representation system according to claim 7, wherein the controller executes a control program to control, based on predetermined representation data, the first group of elevation devices, the second group of elevation devices, and the light projector.
